(19) United States
(12) Patent Application Publication
(10) Pub. No.: US 2007/0143173 A1
(43) Pub. Date: Jun. 21, 2007

(54) METHOD AND SYSTEM FOR ANONYMOUS COMMUNICATION OF INFORMATION ABOUT A HOME

(76) Inventors: Jay S. Walker, Ridgefield, CT (US); James J. Jorasch, Stamford, CT (US); Magdalena M. Fincham, Ridgefield, CT (US); Kathleen M. Van Luchene, Santa Fe, NM (US); John M. Packes JR., Hawthorne, NY (US)

Correspondence Address: Michael D. Downs, Five High Ridge Park, Stamford, CT, 06905, US

(21) Appl. No.: 11/673,064

(22) Filed: Feb. 9, 2007

Related U.S. Application Data
(63) Continuation of application No. 10/798,012, filed on Mar. 11, 2004.
Application No. 10/798,012 is a continuation-in-part of application No. 09/410,818, filed on Oct. 1, 1999, now abandoned.

(51) Int. Cl. G07G 1/00; G06F 17/30

(52) U.S. Cl. 705/10

(57) ABSTRACT

A system for establishing anonymous communications includes a plurality of party terminals, a plurality of requester terminals, and a central controller. The system receives and stores party data about respective parties. In some embodiments, a party may be a homeowner. Upon receiving criteria for parties of interest from a requester terminal and authorization from respective parties, the central controller releases to the requester party associated with the parties. The system also establishes communications channels between parties and the requester, while maintaining their anonymity.

### CROSS-REFERENCE TO RELATED APPLICATIONS

The present application is a continuation of U.S. patent application Ser. No. 10/798,012, filed Mar. 11, 2004, entitled “METHOD AND SYSTEM FOR ANONYMOUS COMMUNICATION OF INFORMATION ABOUT A HOME”, which is a continuation-in-part of U.S. patent application Ser. No. 09/410,818, filed Oct. 1, 1999, now abandoned, entitled “SYSTEMS AND METHODS WHEREIN PAYMENT IS PROVIDED TO A HOMEOWNER IN EXCHANGE FOR ALLOWING INFORMATION ABOUT A HOME TO BE TRANSMITTED”.

Each of the above-referenced applications is incorporated by reference herein in its entirety.

The present application is also related to: (i) U.S. patent application Ser. No. 11/427,369 filed Jun. 29, 2006, entitled “METHOD AND SYSTEM FOR ANONYMOUS COMMUNICATION OF INFORMATION ABOUT A HOME”, (ii) U.S. patent application Ser. No. 11/427,388 filed Jun. 29, 2006, entitled “METHOD AND SYSTEM FOR ANONYMOUS COMMUNICATION OF INFORMATION ABOUT A HOME”, (iii) U.S. patent application Ser. No. 11/427,391 filed on Jun. 29, 2006, entitled “METHOD AND SYSTEM FOR ANONYMOUS COMMUNICATION OF INFORMATION”, (iv) U.S. patent application Ser. No. ______ (04-0100-C4) filed Feb. 9, 2007, entitled “METHOD AND SYSTEM FOR ANONYMOUS COMMUNICATION OF INFORMATION”, and (v) U.S. patent application Ser. No. ______ (04-01 0-C5) filed Feb. 9, 2007, entitled “METHOD AND SYSTEM FOR ANONYMOUS COMMUNICATION OF INFORMATION”.

### BACKGROUND OF THE INVENTION

1. Field of the Invention

The present invention relates to establishing anonymous communications between two or more parties. More specifically, the invention relates to controlling the release of confidential or sensitive information of at least one of the parties in establishing anonymous communications.

2. Description of the Related Art

The need for anonymous communications can be found in everyday situations. Police hotlines solicit tips from the public to help solve a crime, often without requiring callers to give their names. Cash rewards are often offered for the return of missing items with no questions asked.

One form of anonymity involves “shielded identity,” where a trusted agent knows the identity of a masked party, but does not reveal that identity to others except under very special circumstances. Unless otherwise specified, the term “anonymity” is used throughout this application interchangeably with the notion of shielded identity.

Shielded identity appears in a wide range of useful and commercial functions. A company might run an employment advertisement in a newspaper with a blind P.O. box known only to the publisher. A grand jury could hear testimony from a witness whose identity is known only to the prosecutor and the judge, but is concealed from the jurors, the accused, and opposing counsel. A person could identify a criminal suspect from a lineup of people who cannot see him. A recruiter could contact potential candidates for a job opening without revealing the client's name. Witness protection programs are designed to shield the true identity of witnesses enrolled in the programs. A sexual harassment hotline could be set up for victims of sexual harassment to call in with their complaints, while promising to protect the callers' identities.

The above examples illustrate the need for anonymity or shielded identity due to a fear of exposure. The need for anonymity can also be motivated by a desire for privacy. For instance, donors may wish to make an anonymous charitable contribution, an adoption agency typically shields the identity of a child's birth mother, a Catholic confessional offers anonymous unburdening of the soul, and local phone companies maintain millions of unlisted telephone numbers accessible only by special operators.

The concepts of anonymity and shielded identity do not lend themselves to conventional communication systems. While it is possible to send and receive anonymous messages, such as a postcard with no return address or a call placed from a pay phone, it is difficult for parties engaged in multiple communication episodes to remain anonymous from one another. In general, conventional communication systems are premised upon the notion that communicating parties know each other's identity. For the purposes of this invention, the term “communications system” refers to any system that facilitates an ongoing cycle of messages and responses.

Most current communications systems, whether written or oral, do not permit an ongoing, multi-party, shielded identity dialogue. For example, letters need an address to be delivered, calling someone on the phone requires a phone number, and meeting face-to-face provides for visual identification. The process involved in most ongoing communication systems is simply not conducive to retaining concealed identities.

Yet, in some cases, concealing identity can actually encourage or facilitate communication between unwilling or cautious parties. For example, a party negotiating a peace treaty with another may be unwilling to reveal his identity because, if the negotiations fall, that party might be exposed or subjected to potential blackmail.

One specific example of the need for concealing identities is in the employment search process, where the release of the name of the hiring company (or the position involved) could be damaging to the company. The hiring company might be concerned about how potential competitors would use the knowledge that the company is searching for employees to upset customers who are relying on the stability of the company. Mere speculation that a company is searching for a new president could dramatically reduce the price of the company's stock. To find potential candidates for the vacant position, the company could engage an employment search firm to discretely find potential candidates without disclosing to the market, or even potential candidates, the company's identity until the company decides to confide in or hire a particular candidate.

In engaging such employment search firms, however, a hiring company entails some risk that the search firm will prematurely or indiscriminately reveal the company's identity to a potential candidate. Search firms are generally compensated based upon the number of successful placements, and thus are motivated to make vacant positions appear as attractive as possible to potential candidates. In doing so, search firms could be tempted to reveal enough information about the company for potential candidates to discover the identity of the company, or, for that matter, the firms may reveal the company's identity itself Accordingly, hiring companies cannot be counted upon to maintain effective control of what information is released to potential candidates, and thus are unable to instill any satisfactory degree of confidence in their clients about the confidential status of their search for job replacements.

The use of search firms also creates inefficiencies. In dealing with a search firm, candidates looking for a new job may engage in a dialogue with the search firm, asking a series of detailed questions about the particular job, company expectations, various qualification criteria, benefits, options, perks, and other factors, all without the candidate knowing the name of the hiring company. In response, the search firm may reveal, from general to specific, information about the hiring company. For instance, in response to questions, the search firm may successively reveal that the hiring company is a Fortune 500 company, a transportation company, an airline, headquartered in the Midwest, and, finally, that it is United Airlines. In return, the candidate may also authorize the search firm to release information about itself. For instance, the search firm may disclose that the candidate is employed at a small software company, that he is the head of a software development group of seven programmers, then that he is earning $75,000 plus a $20,000 bonus in his current job, then that he is located in the Stamford, Conn. area and then finally his identity.

From the outside, these actions may appear to be a type of “dance,” where each party seeks to learn the necessary information to keep the process moving forward. To answer any difficult questions, the search firm, trusted by both parties, facilitates an assisted dialogue between the candidate and the company.

By creating this additional layer in the communication process, however, the amount of effort and expense incurred by the hiring party and the candidates increases. Further, using such a search firm creates delays in communicating information between the company and the candidates and increases the likelihood that misunderstandings may occur.

In addition, the success of a search firm to fill a position is limited by the number of candidates that the search firm contacts. Search firms may target only certain individuals while overlooking, many other qualified candidates who, if contacted, would have been very interested in considering the available positions. As such, search firms often do not reach a large pool of potential candidates. Search firms also know that the candidates most qualified for jobs are those that are currently employed. Recruiters would love to be able to show these coveted employees even better opportunities. Unfortunately, search firms have no way of identifying, and contacting, these prime candidates. Present systems for recruiting typically rely on the candidate to present himself to the recruiter—at a substantial risk to the employee. No system currently gives an employee the incentive and protection he needs to feel comfortable submitting his resume.

Another area in which shield identity may be desirable is dating. For example, a person could serve as a match-maker by setting up two people with whom he is acquainted person could serve as a match on a blind date. Before agreeing to go on the date, each acquaintance may ask the match-maker questions about the other person and instruct the match-maker not to reveal his/her identity without prior authorization. Once each of the acquaintances feels comfortable about the other person, he/she may authorize the match-maker to reveal his/her identity and agree to the date.

Again, however, the use of match-makers suffers from the same drawbacks as the search firms. There is little or no control over what information match-makers disclose. For instance, a match-maker may feel greater loyalty to one of the acquaintances and willingly divulge the identity of the other acquaintance. Also, using match-makers slows down the communication process and can result in miscommunication. Finally, the number of people that a match-maker can set up is limited by the number of people to whom the match-maker is acquainted.

Attempts have been made to automate the employment search process and matchmaking process. For instance, U.S. Pat. No. 5,164,897 discloses an automated method for selecting personnel matching certain job criteria. Databases storing employee qualifications are searched to identify which personnel have qualifications matching search criteria. Such a system, however, does not provide anonymous communications between the employer and the employee and does not provide control over the release of information stored within those systems to others. Thus, there is a need for a system that allows users to exercise control over the release of information to others and that provides efficient anonymous communication.

### SUMMARY OF THE INVENTION

Accordingly, the present invention is directed to a communications method and system that obviates problems due to limitations and disadvantages of the prior art.

A goal of the invention is to provide a communication system incorporating a central database of information supplied by one or more of parties and managed by a central administrator, where all parties to the system can manage and control the release of any or all information about themselves or their identities, and where such a system allows for electronic-based communications between the parties without the necessity of revealing the identity of either party.

Another goal of the invention to allow parties to submit criteria for searching a trusted agent's confidential database and receive a count of the number of records that satisfy the criteria, without revealing the identities of the parties associated with those records.

A further goal of the invention is to allow a system administrator to send a request for authorization to release information about a party to a searching g party.

Other goals of the invention are to provide a system that encrypts communications between parties to maintain the anonymity of the parties; to authenticate searchable information contained in a central database for release to parties; to allow one or both parties to receive compensation for contributing or maintaining information accessible in a database; and to allow one party to apply a customized scoring algorithm to information contained about other parties in a database.

Still other goals of this invention are to provide a system for a trusted agent to act as an anonymous remailer or communicate via e-mail or other electronic means with specific outside parties requested or identified by one of the parties to validate information about the parties.

Yet another goal of the invention is to be able to store and authenticate such information that may be provided by outside parties in a central database while allowing the outside parties to retain control over the release of respective information to other parties.

This invention meets these goals by allowing a party to maintain effective control over the timing and release of certain information stored in a database, including the party's identity and other relevant data about the party, to another party. This controlled release of identity can be performed gradually in a series of steps where the party authorizes release of more and more information. The invention also authenticates information stored in the database before releasing the information, thereby improving the reliability of the released information. Finally, the invention establishes a communications channel between a party and a requester while not necessarily revealing the identity of the party and/or the requester to each other. The controlled release of information in the invention allows for new improvements in the quality of the communication process when one party to the process would suffer significant costs or be exposed to significant risks if their identity were released prematurely or indiscriminately.

To achieve these and other objects, and in accordance with the purposes of the invention, as embodied and broadly described, one aspect of the invention includes a method for providing the controlled release of information in a communication system. In this method, party data corresponding to at least one party is securely maintained in the system. A request for party data that is securely maintained in the system is received from a requester. Each party is queried to specify which respective party data the system is authorized to release to a requester. Only the requested party data that respective parties have authorized the system to release is transmitted to the requester, while the anonymity of the respective parties is maintained.

In another aspect, the invention includes an apparatus for providing the controlled release of information. This apparatus includes a device for securely maintaining party data corresponding to at least one party; a device for receiving, from a requester, a request for party data contained in the means for securely maintaining party data; a device for querying each party to specify which respective party data is authorized for release; and a device for transmitting to the requester only the requested party data that respective parties have authorized for release, while securely maintaining the anonymity of the respective parties.

### BRIEF DESCRIPTION OF THE DRAWINGS

The accompanying drawings provide a further understanding of the invention and are incorporated in and constitute a part of this specification. The drawings illustrate preferred embodiments of the invention, and, together with the description, serve to explain the principles of the invention.

In the drawings:

FIG. 1 illustrates one embodiment of the present invention;

FIG. 2A illustrates a block diagram of the central controller of the system in accordance with the embodiment in FIG. 1;

FIG. 2B illustrates the contents of a party data database and a requester data database in accordance with the embodiment in FIG. 1;

FIG. 2C illustrates the contents of a verification database and an account database in accordance with the embodiment in FIG. 1

FIG. 3 illustrates a block diagram of a party terminal in accordance with the embodiment in FIG. 1;

FIG. 4 illustrates a block diagram of a requester terminal in accordance with the embodiment in FIG. 1;

FIG. 5 illustrates a flow diagram of a preferred method for establishing anonymous communications in accordance with this invention;

FIGS. 6A-6B illustrate a flow diagram of a preferred method for searching for and releasing party data in accordance with this invention;

FIG. 7 illustrates a flow diagram of a preferred method for verifying the authenticity and accuracy of party data in accordance with this invention;

FIG. 8 illustrates a flow diagram of a preferred method for opening a communications channel between a party and a requester in accordance with this invention; and

FIG. 9 illustrates a detailed flow diagram of a preferred method for transmitting party and requester information in a communications channel in accordance with this invention.

FIG. 10 is a block diagram of a remote home viewing system in accordance with the present invention;

FIG. 11 is a block diagram of a viewer device or a homeowner device in accordance with an embodiment of the present invention;

FIG. 12 is a block diagram of a central server of the remote home viewing system of FIG. 10;

FIGS. 13A and 13B are an illustration of a database table referred to as the home database in FIG. 12;

FIG. 14 is an illustration of a database table referred to as the picture database in FIG. 12;

FIG. 15 is an illustration of a database table referred to as the viewer database in FIG. 12;

FIG. 16 is an illustration of a database table referred to as the collected demand database in FIG. 12;

FIG. 17 is a flowchart that illustrates the operations carried out for receiving and transmitting information associated with a homeowner's home according to an embodiment of the present invention;

FIG. 18 is a flowchart that illustrates the operations carried out for storing a homeowner's home records in the home database according to an embodiment of the present invention;

FIGS. 19A-19B are a flowchart that illustrates operations carried out for displaying pictures stored in the picture database in FIG. 12;

FIG. 20 is a flowchart that illustrates the operations carried out for providing a payment to a homeowner according to an embodiment of the present invention;

FIGS. 21A-21B are a flowchart that illustrates operations carried out for storing and displaying video images of a homeowner's home according to an embodiment of the present invention;

FIGS. 22A-22B are a flowchart that illustrates operations carried out for collecting demand according to an embodiment of the present invention; and

FIGS. 23A-23B are a flowchart that illustrates operations carried out for receiving and transmitting images of a homeowner's home, including an offer presented by the viewer, according to an embodiment of the present invention.

### DETAILED DESCRIPTION OF THE INVENTION

System Structure

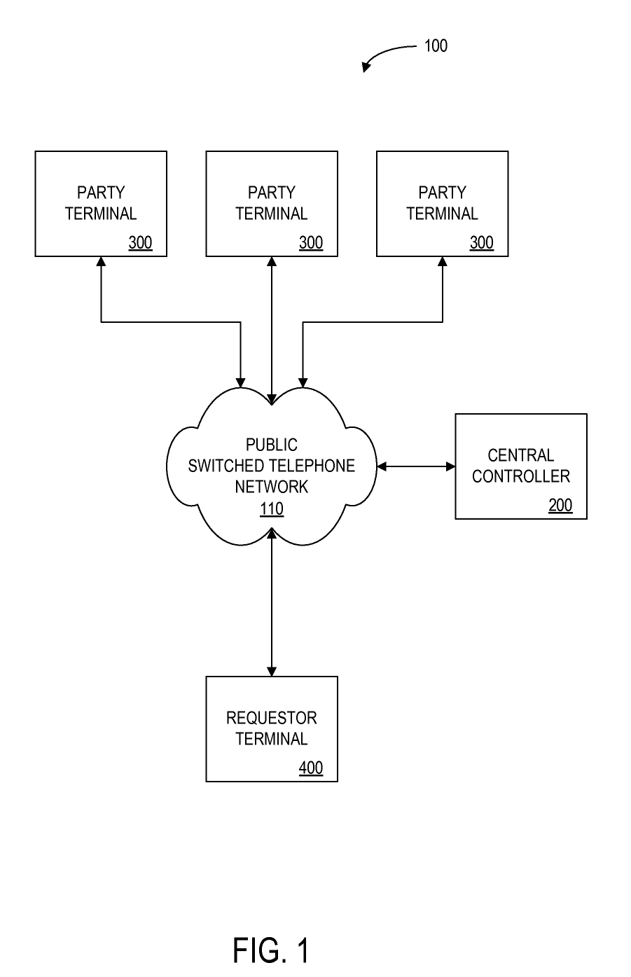

FIG. 1 illustrates one embodiment of an anonymous communication system 100 according to this invention. System 100 identifies parties having characteristics of interest to a requester, releases certain information about the identified parties to the requester with authorization from the parties, releases certain Information about the requester to the identified parties with authorization from the requester, and provides a communications channel between the identified parties and the requester while maintaining their anonymity. For example, system 100 can be used to allow an employer (the requester) to communicate with prospective candidates (the parties) whose background satisfies employment criteria provided by the employer without revealing the identity of the employer or the identities of the candidates. In a specific example, a software company may want to hire a programmer with 5+years experience in writing C++, who is willing to live in Seattle, who will work 12-14 hour days 6 days a week, who will work for between $100,000, to $150,000 in salary plus bonuses, and who wants the opportunity to work for a startup with stock options in a publicly-traded company that could effectively double his salary. System 100 could identify a dozen candidates from resumes stored in a database, release information about these candidates only as authorized to the company, and deliver messages between the company and candidates without the company ever knowing the candidates identities. Although the invention can be used in connection with other applications, for the purpose of illustration, the employment search example is used throughout the specification to describe the invention.

System 100 includes a public switched phone network 110, a central controller 200, party terminals 300, and requester terminals 400. Central controller 200, party terminals 300, and requester terminal 400 preferably connect to network 110 through respective two-way communication links. Parties (e.g., candidates) access system 100 through respective party terminals 300, and a requester (e.g., an employer) accesses system 100 through requester terminal 400. The flow of data from terminals 300 and 400 is preferably limited and controlled by central controller 200.

Under the control of central controller 200, public switched telephone network 110 routes data to and from central controller 200, party terminals 300, and requester terminal 400. In a preferred embodiment, network 110 comprises a commercially-implemented network of computer-controlled telephone switches operated by, for example, a telephone company. Network 110 may also include communication networks other than a public switched telephone network, such as a wireless telephone network, a paging network, or the Internet.

Central controller 200 controls the flow of data to and from party terminals 300 and requester terminal 400. Preferably, central controller 200 stores and authenticates the authorship of “party data” and “requester data” received from party terminals 300 and requester terminal 400, respectively. “Party data” comprises data about or corresponding to a respective party. “Requestor data” comprises data about or corresponding to the requester. In the employment search example, party data would include information that may be of interest to an employer about respective candidates, such as a candidate's identity, the candidate's address, the candidate's vital statistics, the candidate's work experience, the candidate's educational background, and the candidate's interests.

In one embodiment used with an employment system, each party fills out an electronic form that gets converted into an HTML format. This presents the party's employment history as a “hyper-resume”. When released to a requester, this resume allows the requestor to get more information about certain areas of a party's history. The hyper-links can point to additional text, QuickTime video, JPG photos or audio clips, allowing for a rich presentation of information about the party. Requestor data would include information about the employer, such as the employer's identity, the number of its employees, the locations of its offices, the industry in which the employer operates, the positions available and their job descriptions, fiscal information about the employer, and the history of the employer. The requestor data is collected and stored using similar techniques to those outlined above for an employee's employment history.

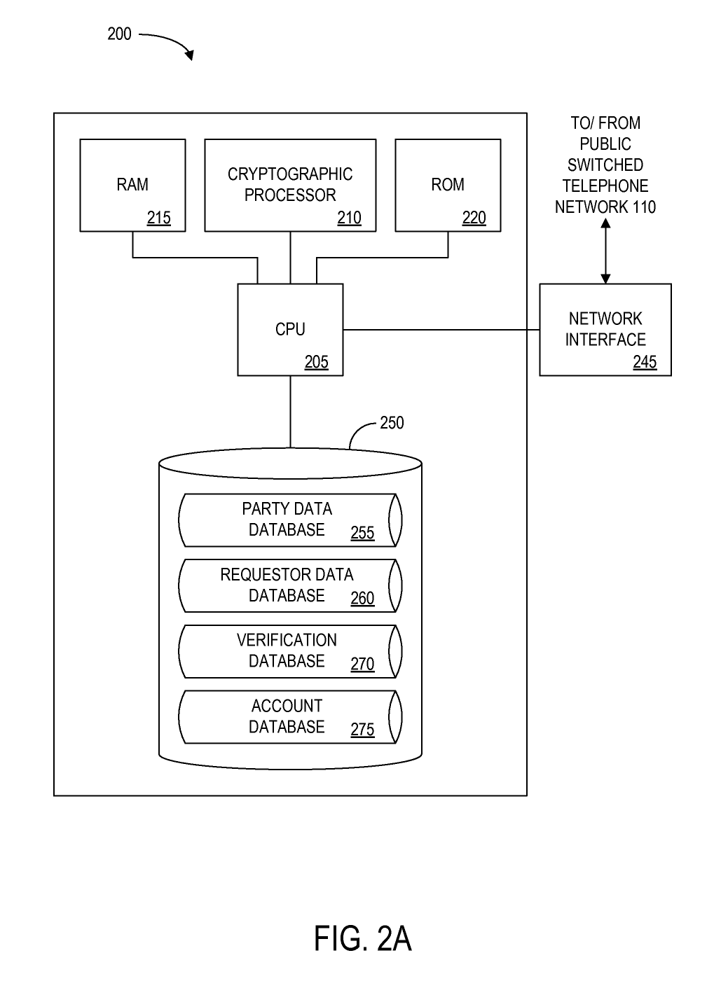

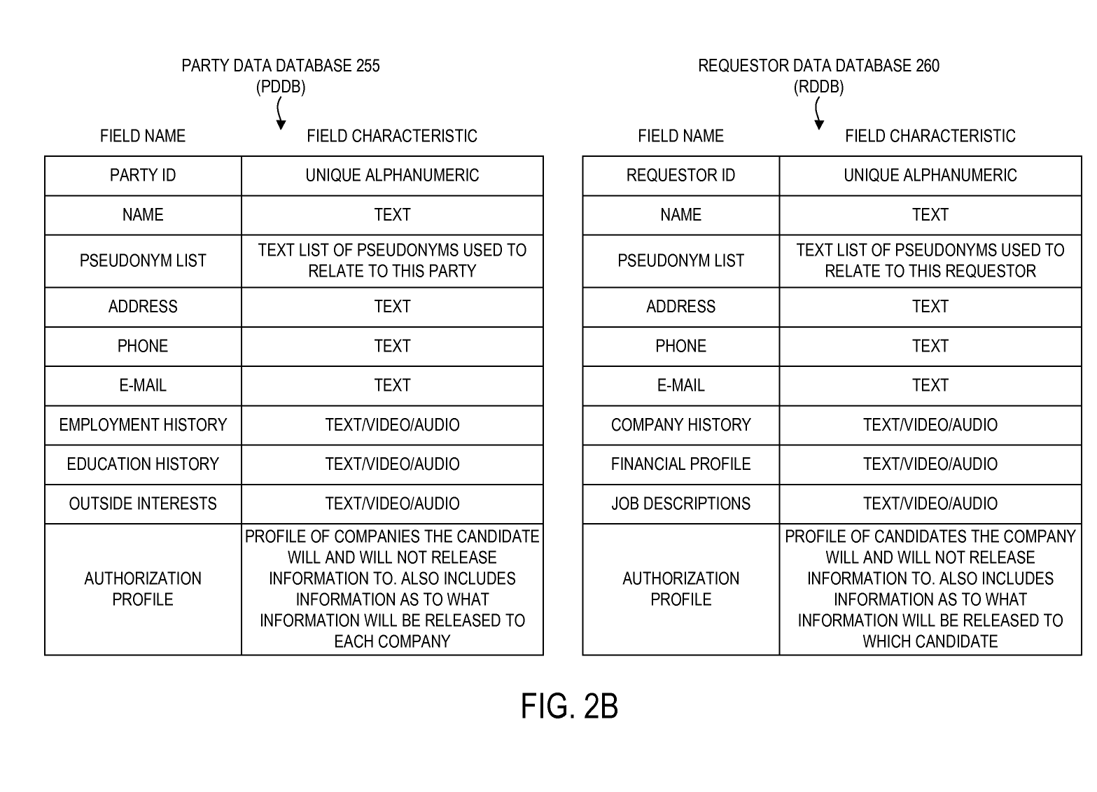

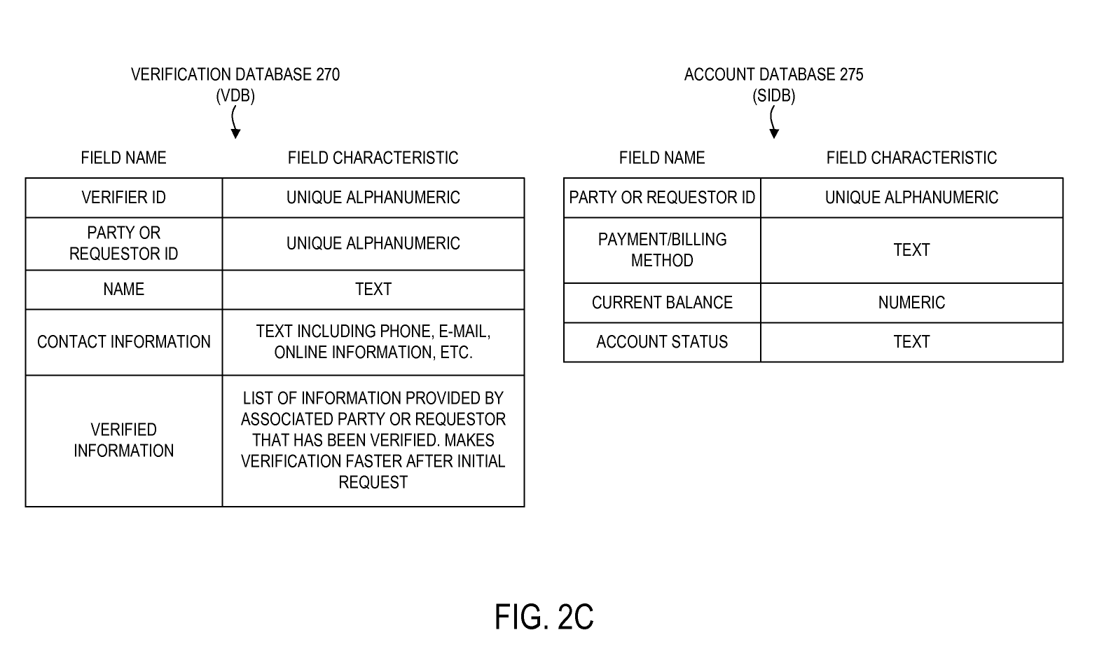

In addition, central controller 200 controls the release of requestor data and party data that the requestor and respective parties, respectively, have authorized for release. Central controller 200 also establishes a communications channel between party terminals 300 and requestor terminal 400, while maintaining the anonymity of the parties using party terminals 300 and the requestor using requestor terminal 400. The structure of controller 200 is described in greater detail below in connection with FIG. 2A.

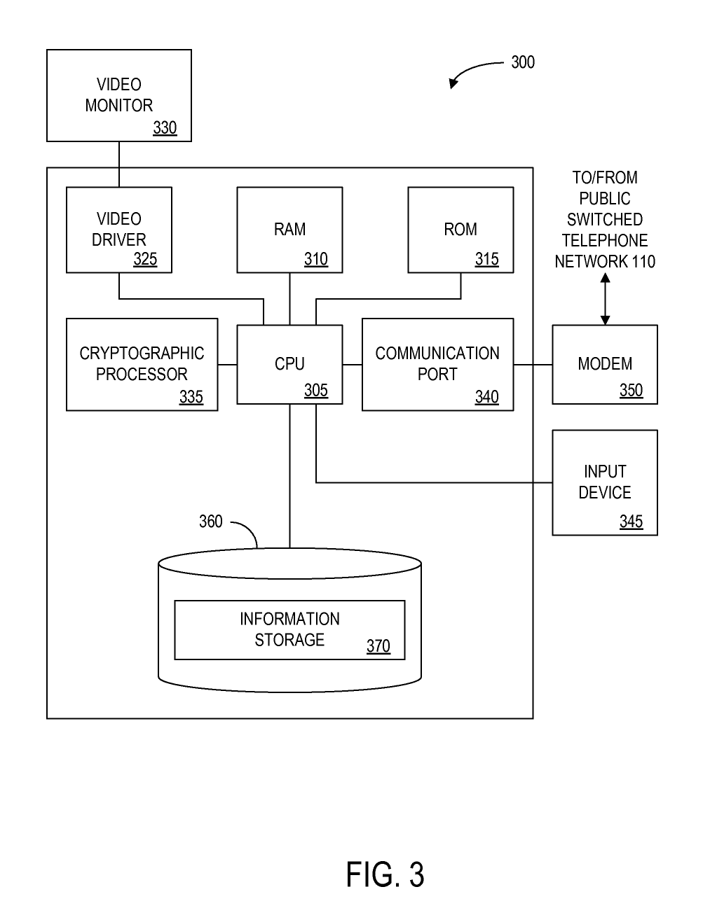

Party terminal 300 provides a party with an interface to system 100. Preferably, party terminal 300 allows a party to enter party data and transmits it to central controller 200 via network 110. Party terminal 300 also allows a party to indicate which of the entered party data system 100 is authorized to release to a requestor, view requestor data, and communicate anonymously with the requestor at requestor terminal 400. The structure of party terminal 300 is described in greater detail in connection with FIG. 3.

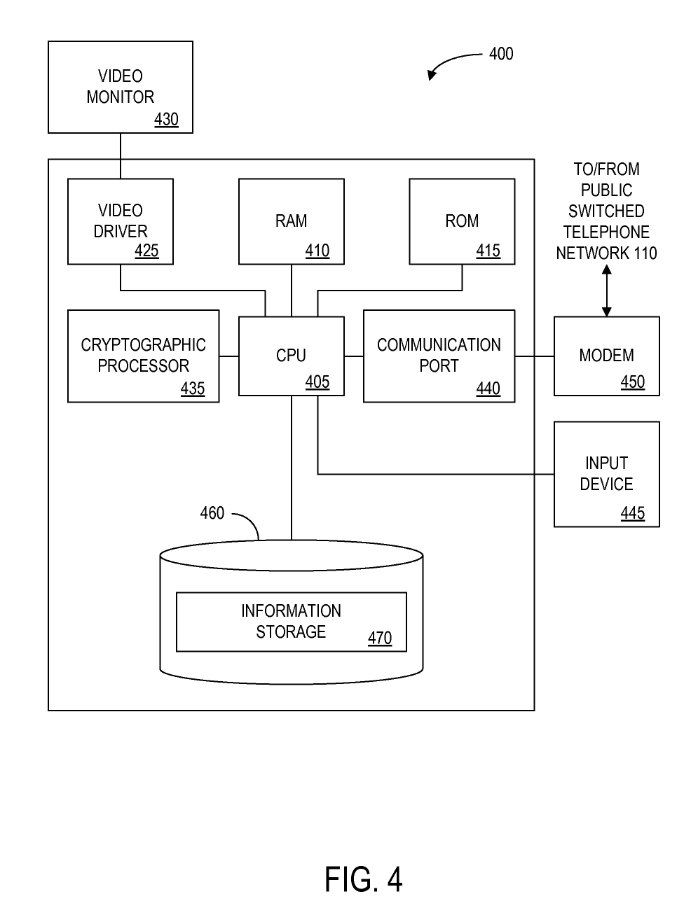

Requestor terminal 400 provides a requestor with an interface to system 100. In a preferred embodiment, requestor terminal 400 allows a requestor to enter requestor data and transmits the requestor data to central controller 200 via network 110. Requestor terminal 400 also allows a requestor to enter search criteria about parties of interest, to indicate which of the entered requestor data system 100 is authorized to release to a particular party, view party data, and communicate with parties at party terminals 300. The structure of requestor terminal 400 is described in greater detail in connection with FIG. 4.

FIG. 2A illustrates a block diagram of central controller 200. As shown in FIG. 2A, central controller 200 includes CPU 205, cryptographic processor 210, RAM 215, ROM 220, network interface 245, and data storage device 250. Data storage device 250 includes a plurality of databases, including party data database 255, requestor data database 260, verification database 270, and account database 275, as well as program instructions (not shown) for CPU 205. CPU 205 is connected to each of the elements of central controller 200.

The databases in data storage device 250 are preferably implemented as standard relational databases capable of supporting searching and storing multimedia information such QuickTime movies, photographs, and audio. FIG. 2B illustrates exemplary as text, vi record layouts for party data database 255 and requester data database 260, and FIG. 2C illustrates record layouts for verification database 270 and account database 275. Each record layout preferably comprises a two-dimensional array of information with one column for “Field Name” and another column for “Field Characteristic”. The rows correspond to respective fields.

The “authorization profile” field 256 preferably comprises a list of rules for releasing party or requester data. For example, the rules could simply include a list of companies to which party data is not to be released, or include characteristics of certain companies to which party data can be released, such as companies that are in the Fortune 500 and have stock option plans.

Verification database 270 preferably includes cross-referencing fields (not shown) to party data database 255 and requester data database 260. This allows indexing by verified information as well as other types of searches.

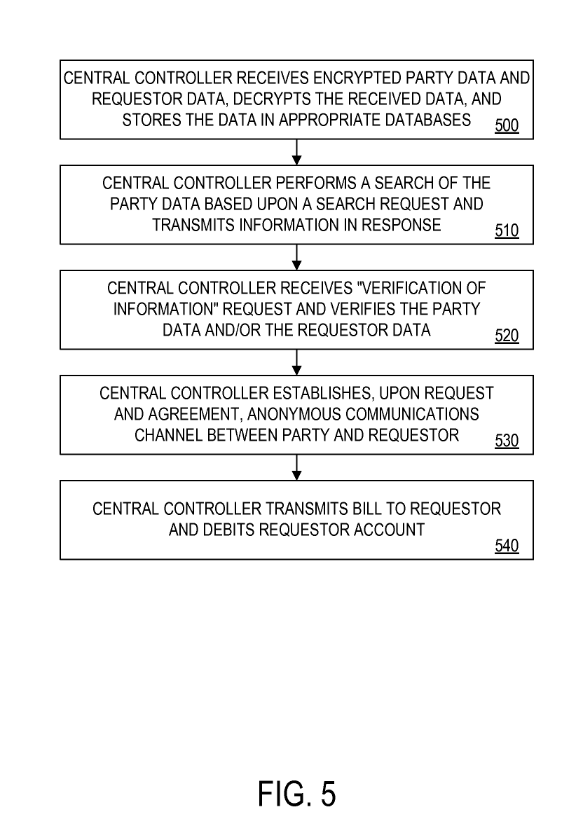

CPU 205 executes program instructions stored in RAM 215, ROM 220, and data storage device 250 to perform various functions described in connection with FIGS. 5-9. In a preferred embodiment, CPU 205 is programmed to maintain data, including party data and requester data, in storage device 250. CPU 205 receives party data and requester data from network 110 through network interface 245 and stores the received party data and requester data in databases 255 and 260, respectively. CPU 205 is also programmed to receive and store information in party database 255 and requester database 260 indicating which of the party data and requester data respective parties and requesters have authorized for release. Upon receipt of a request for authentication, CPU 205 transmits a verification request to a verification authority to authenticate the origin, authorship, and integrity of the party data and requester data stored in databases 255 and 260, respectively, and maintains a record of the verification request in database 270.

CPU 205 is also preferably programmed to search databases 255 and 260 and transmit information in response to the search. CPU 205 receives a search request containing certain criteria and searches the databases of storage device 250 to find matches. Based upon the search, CPU 205 releases certain information to the requester and the parties. Also, CPU 205 preferably assigns pseudonyms to each party and requester, and stores the pseudonyms in databases 255 and 260, respectively. The pseudonyms can include coded identifiers, web page addresses, bulletin board addresses, pager numbers, telephone numbers, e-mail addresses, voice mail addresses, facsimile telephone numbers, and postal mail addresses.

CPU 205 receives search criteria pertaining to parties of interest to the requester and searches database 255 to identify parties whose party data satisfies the search criteria. There are a number of search techniques that can be used including, keyword, fuzzy logic, and natural language search tools. For example, an employer could search for candidates with the following criteria: “two years of patent writing experience and lives in New England”. CPU 205 compares the criteria against each party registered with the system using one or more search algorithms and transmits to the requester the number of parties identified. If CPU 205 receives a request for party data corresponding to the identified parties, CPU 205 transmits to requester terminal 400 the party data that the identified parties previously authorized for release along with respective pseudonyms. CPU 205 can also transmit queries to party terminals 300 inquiring whether respective parties authorize the release of additional party data. If CPU 205 receives a request for requester data from a party, CPU 205 transmits to the appropriate party terminal 300 the request data that the requester previously authorized for release, along with a pseudonym corresponding to the requester.

CPU 205 is preferably also programmed to provide an anonymous communications channel between party terminals 300 and requester terminal 400. CPU 205 receives a request for an anonymous communications channel along with a pseudonym of a party and a requester. In one embodiment, CPU 205 establishes either a real-time or non-real-time communications channel between the party and the requester corresponding to the received pseudonyms. For example, CPU 205 could transmit control signals to configure network 110 to provide a direct telephone connection between the party and the requester at their respective terminals 300 and 400, thereby establishing a real-time communications channel. In another example, CPU 205 could receive and store electronic mail messages in electronic mailboxes assigned to the party and the requester for their retrieval, thereby establishing a non-real-time communications channel.

CPU 205 preferably comprises a conventional high-speed processor capable of executing program instructions to perform the functions described herein. Although central controller 200 is described as being implemented with a single CPU 205, in alternative embodiments, central controller 200 could be implemented with a plurality of processors operating in parallel or in series.

RAM 215 and ROM 220 preferably comprise standard commercially-available integrated circuit chips. Data storage device 250 preferably comprises static memory capable of storing large volumes of data, such as one or more floppy disks, hard disks, CDS, or magnetic tapes.

Network interface 245 connects CPU 205 to network 110. Interface 245 receives data streams from CPU 205 and network 110 formatted according to respective communication protocols. Interface 245 reformats the data streams appropriately and relays the data streams to network 110 and CPU 205, respectively. Interface 245 preferably accommodates several different communication protocols.

Cryptographic processor 210 is programmed to encrypt, decrypt, and authenticate the stored data in each of the databases described above. Cryptographic processor 210 encrypts and decrypts data received by and transmitted from CPU 205. In a preferred embodiment, all party data and requester data are encrypted before being, transmitted onto network 110. Also, processor 210 encrypts the data before CPU 205 transmits such data via network 110. Any encrypted data received by CPU 205 is decrypted by processor 210. The cryptographic protocols used by cryptographic processor 210 are described below in the section entitled “Cryptographic Protocols.”

FIG. 3 illustrates a block diagram of party terminal 300, according to one embodiment of the invention. Party terminal 300 includes CPU 305, which is connected to RAM 310, ROM 315, video driver 325, cryptographic processor 335, communication port 340, input device 345, and data storage device 360. Video monitor 330 is connected to video driver 325, and modem 350 is connected to communication port 340 and public switched phone network 110.

CPU 305 executes program instructions stored in RAM 310, ROM 315, and information storage 370 to carry out various functions associated with party terminal 300. In a preferred embodiment, CPU 305 is programmed to receive data from input device 345, receive data from communication port 340, output queries and received data to video driver for display on video monitor 330, and output data to communication port 340 for transmission by modem 350. CPU 305 preferably transmits the data to cryptographic processor 335 for encryption before outputting data to communication port 340 for transmission to network 110. When CPU 305 receives encrypted data, CPU 305 transmits the encrypted data to cryptographic processor 335 for decryption.

CPU 305 preferably comprises a high-speed processor capable of performing the functions described herein. RAM 310 and ROM 315 comprise standard commercially-available integrated circuit chips. Information storage 370 comprises static memory capable of storing large volumes of data, such as one or more of floppy disks, hard disks, CDs, or magnetic tapes. Information storage 370 stores program instructions and received data.

Video driver 325 relays received video and text data from CPU 305 to video monitor 330 for display. Video monitor 330 is preferably a high resolution video monitor capable of displaying both text and graphics. Cryptographic processor 335 encrypts and decrypts data in accordance with conventional encryption/decryption techniques and is preferably capable of decrypting code encrypted by cryptographic processor 210. Communication port 340 relays data between CPU 305 and modem 350 in accordance with conventional techniques. Modem 350 preferably comprises a high-speed data transmitter and receiver. Input device 345 comprises any data entry device for allowing a party to enter data, such as a keyboard, a mouse, video camera, or a microphone. The operation of party terminal 300 described in greater detail in connection with FIGS. 5-9.

FIG. 4 illustrates a block diagram of requester terminal 400 according to the invention. Terminal 400 in FIG. 4 includes CPU 405, which is connected to RAM 410, ROM 415, video driver 425, cryptographic processor 435, communication port 440, input device 445, and data storage device 460. Video monitor 430 is connected to video driver 425, and modem 450 is connected to communication port 440 and public switched telephone network 110. Terminals 300 and 400 are shown in FIGS. 3 and 4 to be structurally similar, though different reference numerals are used. As such, a more detailed description of terminal 400 can be obtained by referring to the above description of terminal 300. In a preferred embodiment, however, terminals 300 are used by parties, whereas terminal 400 is used by a requester.

Cryptographic Protocols

As described above, system 100 encrypts data before transferring such data between system users (including both parties and requesters) and central controller 200, thereby providing various levels of security and privacy protection. As used throughout this section, the term “users” refers to both parties and requesters. A book entitled Applied Cryptography: Protocols, Algorithms, And Source Code In C by Bruce Schneier (2d Ed, John Wiley & Sons, Inc., 1996) describes in detail numerous cryptographic protocols that can be used. These protocols can be understood from the following basic overview.

The following notation is used throughout the description of cryptographic protocols:
PKE_{A}: refers to the public encryption key of user A. This can be an RSA public key or a key for some other public key encryption scheme.
SKE_{A}: refers to the secret decryption key corresponding to encryption key PKE_{A}.
PKS_{A}: refers to the public component of user A's signature key. This can be a DSS key or a key for some other public key signature scheme. It can also be the same key as PKE_{A} in public key systems like RSA.
SKS_{A}: refers to the private signature key corresponding to PKS_{A}. It can also be the same key as SKE_{A} in public key systems like RSA.
E_{PKE}(M): refers to the encryption of the plain text message M with the public encryption key PKE.
D_{SKE}(C): refers to the decryption of the cipher-text message C with the secret decryption key SKE.
E_{K}(M): refers to the encryption of message M with a symmetric encryption algorithm and key K. It is apparent from the context whether the protocol uses public key or symmetric key encryption.
D_{K}(C): refers to the decryption of the cipher-text message C with a symmetric encryption algorithm and key K.
S_{SKS}(M): refers to signature of message M with secret signature key SKS.
H(M): refers to the hash of the message M with a cryptographic hash function like MD5 or SHA.
A,B: refers to the concatenation of A and B. This is commonly used when describing messages.

Public key encryption systems are usually several orders of magnitude slower than private (symmetric) key encryption systems. As a result, central controller 200 preferably uses the following protocol or the like to encrypt messages. Suppose that Alice wants to encrypt a message M so that only Bob can read it.
1. Alice obtains Bob's public encryption key, PKE_{B}, generates a random symmetric encryption key K, and encrypts it with Bob's public key.
2. Alice encrypts the message M with the key K using a symmetric encryption algorithm, like Triple-DES or IDEA, and sends
   M₀=E_{PKEB}(K),C
   where C=E_{K}(M).
3. Bob decrypts the key K using his private decryption key
   K=D_{SKEB}(E_{PKEB}(K))
   and uses the key to decrypt the message
      M=D_{K}(C)=DK(E_{K}(M)).

The bulk of the encryption is done using the symmetric encryption algorithm, which is orders of magnitude faster than the public key encryption algorithm. When a user encrypts a message to central controller 200 using central controller 200's public key, it is assumed that the user and central controller 200 carry out the above protocol.

Typical signature schemes (e.g. RSA or DSS) use a key pair for creating signatures and verifying them. One part of the pair, the private part, is used for generating, signatures. The transformation for generating a signature is defined in such a way that only someone who knows the private part of the key pair can generate a signature. Hence, only the owner of the key pair can generate signatures.

The other part of the pair, the public part, is used to verify signatures. Anyone, including the owner of the key pair, can use the public component to verify that a signature is valid. However, it is computationally infeasible to use the public component to forge a signature.

One example of such a signature scheme is the RSA public-key encryption system. In such a system, each user has a public key consisting of a modulus n and an exponent e, where n is a product of two secret primes p and q. The private component is an exponent d such that ed=1(mod(p−1)(q−1)).

To sign a message M with an RSA key pair, the user computes
S=M^{d}(mod n).

where the result S is the signature. In order to verify the signature, a user simply computes
S^{c}=M^{cd}=M(mod n).
The signature verifies correctly if the result of computing Sc (mod n) is the message that the signature is for, i.e. S^{c}=M(mod n). Thus, a user must know d in order to generate a signature.

Public key signature schemes, however, are slow and a user can only sign messages that are smaller than n (when encoded in the ring Z/nZ). One solution is to hash the message M with a cryptographic hashing scheme (e.g. MD5 or SHA), and then sign the hash. The resulting hash usually much smaller than the message and hence easier to sign.

In addition, generating two messages with the same hash is computationally so it is extremely difficult to generate two messages which will have the same signature. Therefore, the following protocol is an RSA-like signature protocol which will preferably be used whenever a user or central controller 200 needs to sign and verify messages and will be known as S_{SKS}(M):

1. Alice generates a message M which she wishes to sign.

2. Alice computes h=H(M), the one-way hash of M with a predetermined hashing algorithm.

3. Alice computes
S=h^{d}(mod n)

which is her signature. Hence,
S^{SKSA}(M)=(H(M))_{SKSA}(mod n).
The following protocol can be used by any user to verify Alice's signature:
1. Bob receives a message M and corresponding, signature S, which he wants to verify. He believes that Alice generated the signature.
2. Bob Computes M′=S_{PKSA} (modn where n is Alice's public modulus (it is specified as part of PKS_{A}).
3. Bob verifies that M=M′. If they match, then Alice's signature verifies successfully. Otherwise the verification fails.

Most of the protocols described require public encryption keys or private signature keys (or both). Each user communicating with central controller 200 should receive encrypted messages from central controller 200 and sign messages that they send to central controller 200. Hence, each user in the system requires a public/private encryption key pair and a public/private signature key pair. As noted above, these pairs could be the same pair in systems like RSA.

Generating a key pair, either signature or encryption, depends heavily upon the intended algorithm. A brief example for generating RSA encryption (and signature) keys is shown below.
1. Central controller 200 determines the size for the public key. Typically, a 768-bit key is the recommended minimum, but 1024-bits provide a better minimum.
2. Central controller 200 generates two primes p and q such that p>sqrt(pq)>q, and p and q are not close together (i.e. they are both roughly sqrt(n) in size, but different in size by two or three bits),
3. Central controller 200 computes n=pq. This is the public modulus.
4. Central controller 200 chooses a public exponent e. Common choices are 3, 17, and 65537(2¹⁶+1).
5. Central controller 200 computes the private exponent d by finding d such that
   Ed=1(mod(p−1)(q−1)).
   Central controller 200 can do this using the extended Euclidean Algorithm.
6. Central controller 200 publishes n and e as the public key. e is the public exponent which people use to encrypt messages to the public key user (a party, requester or central controller 200) or to verify the signature (if the pair is the signature pair). The secret exponent, d, is what is used to decrypt messages sent to the user or to generate signatures.

The primes that central controller 200 chooses are preferably chosen at random. If an attacker can determine p and q, then the attacker can also determine d. Several tests exist for determining whether a randomly chosen number m prime or not. Typically one chooses a random number m and then uses primality tests to determine the first prime greater than or equal to m.

When encrypting, a message to be transmitted or verifying a signature, there needs to be a way of verifying the appropriate public key. One common way is to implement a hierarchical certification system in which each valid public key has a corresponding key certificate. The key certificate is signed by another user's private signature key higher up in the key hierarchy. At the top of the hierarchy is the private signature key of the certificate authority, whom everyone automatically trusts. In this case, the certificate authority would be central controller 200.

The purpose of a certificate is to bind together in some authenticated way a public key, and a set of statements about this public key. The most important statement made is usually who owns the public key. Other potentially important statements might deal with what the key is and is not authorized to do, and when the key expires.

The best-known standard for key certificates is X.509. More detailed information on the construction of X. 509 certificates can be found in CCITT, Dract Recommendation X. 509, “The Directory-Authentication Framework,” Consultation Committee, International Telephone and Telegraph, International Telecommunications Union, Geneva, 1989 or RSA Laboratories, “PKCS #6: Extended-Certificate Syntax Standard,” Version 1.5, November 1993.

In a preferred embodiment of the invention, central controller 200 has at least one signature key pair for which everyone using the system knows the public signature key. In one embodiment of the invention, central controller 200 will use two signature key pairs: one key pair for signing key certificates and one key pair for use in the rest of the protocols, described. Central controller 200 keeps the certificate authority signature pair under lock and key except for when a key certificate needs to be signed. On the other hand, the other signature key pair is available at all times.

Each time a new user (a party or requester) registers with central controller 200, the certificate authority signature key is used by central controller 200 to sign a unique signature key pair for the user. This needs to be done before a user uses their signature key pair for the first time. In one embodiment of the invention, central controller 200 generates a signature key pair and signed key certificate for the user. In an alternate embodiment, the user creates his own key pairs.

Once a user involved in the system has a signed key certificate for his public signature key, he can then use that signature key to sign a key certificate for his public encryption key. Central controller 200, acting as the certificate authority, can also sign the key certificates for encryption keys. This has the advantage of reducing the number of signature verifications. In an embodiment of the present invention, the same method for generating signature key pairs is used for generating encryption key pairs.

A user follows the following basic protocol when registering with central controller 200. Suppose that Alice is such a user:
1. Alice obtains a signature key pair.
2. Alice generates a key certificate for her public signature key, sends a copy of the certificate and the public key to central controller 200, and asks central controller 200 to sign the certificate.
3. Central controller 200 sends Alice a copy of the signed certificate.
4. Alice obtains an encryption key pair.
5. Alice generates a key certificate for her public encryption key and signs it with her private signature key.
6. Alice sends a copy of her public encryption key, along with a copy of the signed key certificate, to central controller 200.

After carrying out this protocol, Alice has a signed signature key and a signed encryption key. Furthermore, any user who wishes to send an encrypted message to Alice or verify her signature can obtain the public key component from central controller 200.

For most of the protocols described used in the invention, it is assumed that central controller 200 stores signatures and the public components for all signature keys used in the system. In addition, it is assumed that each user has a copy of the public components of both of the central controller 200's signature keys. Most communication in system 100 occurs between parties and central controller 200 and between requesters and central controller 200. Where a requester and a party communicate directly, each obtains copies of the other user's public signature and encryption keys from central controller 200.

System 100 may be prone to attempted infiltration, or “attacks,” if the requester and central controller 200 do not use an interlock protocol. Schneier et al., “Automatic Event-Stream Notarization Using Digital Signatures,” in Advances in Cryptology, Proceedings of the Cambridge Protocols Workshop 96, Springer-Verlag, 1996. The interlock protocol “locks” the signatures generated by both users of a protocol to a particular instance of the protocol. This is accomplished by having each user sign a packet which the other user randomly generates. This causes the protocol to be non-deterministic and hence the signatures from one instance do not apply to another. The interlock protocol is described briefly below. Suppose that a party wishes to send a message C to central controller 200:
1. The party generates a random number R₀ and sends
   M₀=R₀, S_{SKSP}(R₀) to Central controller 200.
2. Central controller 200 verifies the party's signature. Central controller 200 then generates a random number R₁ and sends
   M₁=R₁, S_{SKScc}(H(M₀),R₁)
   to the party.
3. The party verifies central controller 200's signature. Central controller 200 then sends
   M₂=C_{SSKSp}(H(M₁),C)
   to central controller 200.

The party and central controller 200 both sign packets using values which cannot be known before the protocol starts. Central controller 200 cannot predict R₀, so it cannot predict what M₀ will look like. Similarly, the party cannot predict R₁, so he cannot predict what M₁ will look like. Hence, each of them must see the packets before they generate the signatures which means that anyone trying to impersonate the party must have the capability of generating signatures on his behalf. This effectively thwarts a replay attack, which can be used to prevent an attacker from gaining information as demonstrates next.

Suppose an attacker Eve observes a party sending some encrypted packets to central controller 200. Although Eve does not know what the packets contain, she might be able to determine that they contain a resume. If a period of time passes in which the party and central controller 200 do not communicate and then central controller 200 sends the party an encrypted message, Eve's confidence that the party sent a resume should increase. Now, if Eve were to send the same encrypted message to central controller 200 that the party originally sent, eventually central controller 200 will send another encrypted message to the party. The attack that Eve (acting as a requester) can mount is that she could submit one or more legitimate search requests to central controller 200 and wait for the results. By paying attention to how the size of the response to the request varies, Eve can deduce some information about the party's data. This sort of attack violates the party's privacy. By using the interlock protocol, Eve cannot replay the party's packets to central controller 200 because she won't be able to complete the interlock protocol.

System Operation

The operation of system 100 is now described in connection with the flow diagrams shown in FIGS. 5, 6, 7, 8 and 9. FIG. 5 illustrates a flow diagram of a method for providing anonymous communication in accordance with one embodiment of the invention.

As shown in FIG. 5, central controller 200 receives encrypted party data and encrypted requester data (step 500). Such encrypted party data and requester data preferably originates from party terminals 300 and requester terminal 400, respectively. In one embodiment, party terminals 300 prompt respective parties to enter party data by displaying requests for information on video monitor 330. For instance, in the employment search example, video monitor 330 would request information that may be of interest to an employer, such as the candidate's identity, the candidate's address, the candidate's vital statistics, the candidate's work experience, the candidate's educational background, and the candidate's interests. The party would enter party data using input device 345. Cryptographic processor 335 would encrypt the entered party data and modem 350 would transmit the encrypted party data to central controller 200 via network 110.

Requestor terminal 400 preferably operates in a similar manner to prompt a requester for requester data, receive and encrypt the requester data, and transmit encrypted requester data to central controller 200. Central controller 200 also assigns a pseudonym to each party and requester whose party data and requester data is stored in databases 255 and 260, respectively.

After receiving the encrypted party data and requester data, cryptographic processor 210 of central controller 200 decrypts the received data (step 500). CPU 205 of central controller 200 stores the decrypted data in databases 255 and 260, respectively (step 500).

Central controller 200 receives a search request to identify those parties whose party data satisfies certain criteria (step 510). In a preferred embodiment, the search request originates from requester terminal 400, where a requester entered the search request. Before requester terminal 400 transmits the search request, cryptographic processor 435 of terminal 400 preferably encrypts the search request. Cryptographic processor 210 decrypts the encrypted search request upon receipt at central controller 200. Central controller 200 then searches party data database 255 and, in response to the search, transmits certain information to requester terminal 400 and party terminal 300 (step 510).

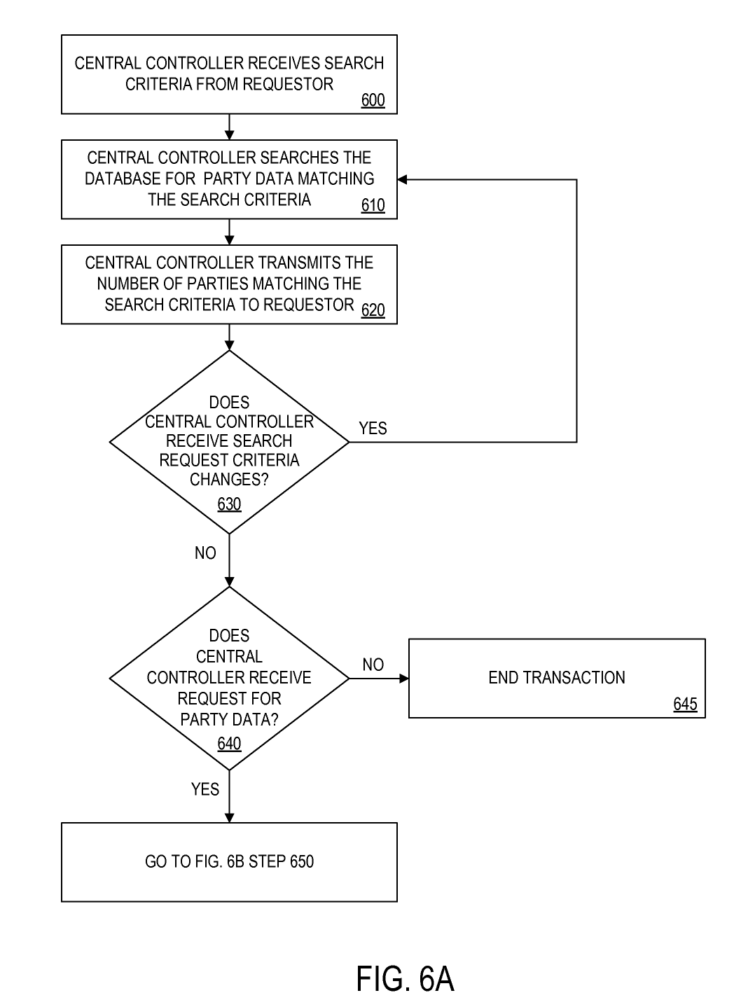

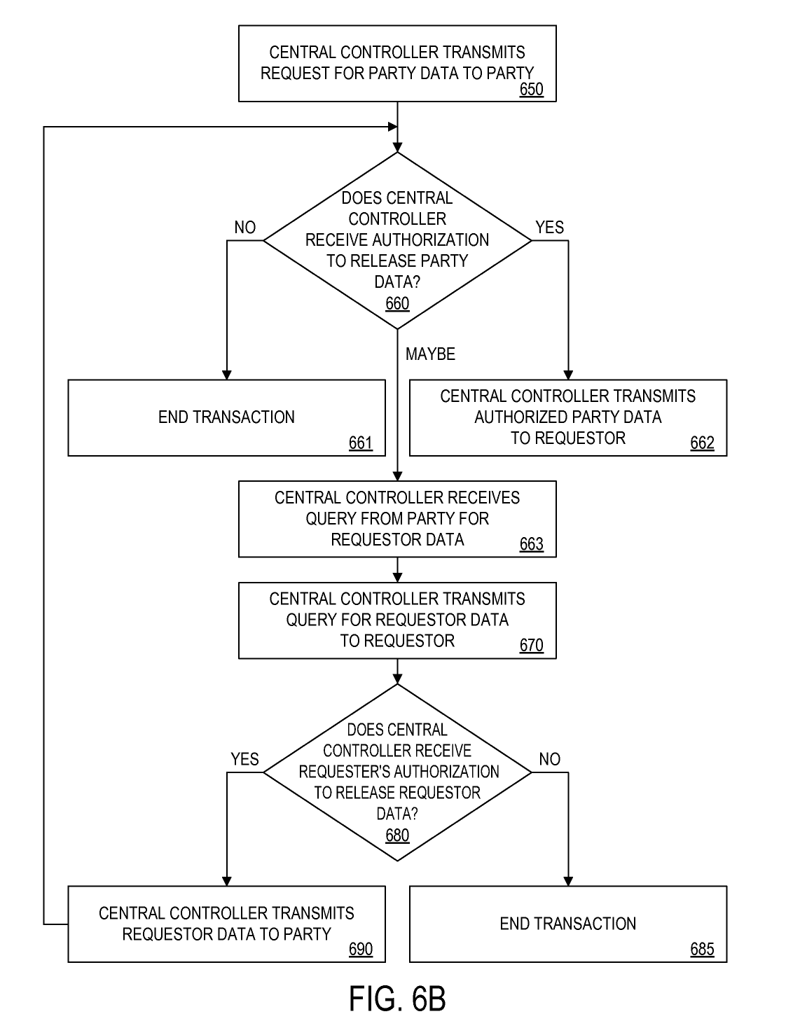

FIGS. 6A and 6B illustrate a flow diagram showing step 510 in more detail. First, central controller 200 receives search criteria from requester terminal 400 (step 600). This search criteria may include, for example, certain employment qualifications or educational background that an employer is interested in.

In response, central controller 200 searches database 255 for party data satisfying the search criteria (step 610). Controller 200 then transmits to requester terminal 400 the results of the search, e.g., number of parties that it found to have party data satisfying the criteria (step 620). Alternatively, the number of parties would be transmitted to requester terminal 400 along with pseudonyms for each of those parties.

Depending on the number of parties found, the requester may refine or modify the search criteria. If the requester chooses to modify the search criteria, the requester enters the new search criteria into requester terminal 400, which transmits the search criteria to central controller 200 (step 630), and steps 610 and 620 are repeated.

Otherwise, central controller 200 determines whether the requester requests party data about those parties found as a result of the search (step 640). Central controller 200 does not transmit any further data to the requester at requester terminal 400 and the transmission ends (step 645).

If the requester chooses to request party data (step 640), the requester enters the party data request into requester terminal 400, which transmits the request to central controller 200. Central controller 200 transmits an authorization request to party terminals 400 for authorization to release respective parties' party data (step 650).

The party receiving the request for authorization can indicate whether to authorize central controller 200 to release some or all of its party data by entering one of three responses into party terminal 300 (step 660). The responses are sent to central controller 200. If central controller 200 receives a response that indicates that the party does not authorize release of any party data, central controller 200 does not provide any party data to requester terminal 400, and the transaction ends (step 661). If, on the other hand, central controller 200 receives a response that indicates that the party authorizes release of some or all of its party data, central controller 200 transmits that party data to requester terminal 400 for the requester (step 662).

Central controller 200 could also receive a response asking for data about the requester before authorizing release of its party data (step 663). If so, central controller 200 transmits a query to the requester at requester terminal 400 asking for authorization to release requester data to the party (step 670). If requester does not authorize release of any requester data to the party (step 680), central controller 200 does not release any requester data to the party and the transaction ends (step 685). If the requester does authorize release of some or all of the requester data to the party (step 680), central controller 200 transmits the authorized requester data to the party (step 690). Central controller 200 then awaits the party's response to see whether central controller 200 is authorized to release party data. To ensure the parties' authorization to release their party data is valid, permission certificates can be used in an alternate embodiment of the present invention. For example, in an employment system embodiment, parties who use the system may not want anyone to know they are hunting for a job. Candidates may not want any of the people they work with to know. As a result, the party would like explicit control over who sees their resume. Therefore, whenever central controller 200 gets a request for a release of party data, central controller 200 needs to obtain explicit permission from the party to send the party's data to the requester. When a party decides to release his party data, he can be sure his data will be released only to the requester making the request. The following is a preferred protocol for a party to issue a permission certificate.
1. A requester “A” submits a request to release party data J and to central controller 200 in order to find out more about the party.
2. Central controller 200 assigns a unique transaction ID, T, to the request and creates a modified request J′=(J,T). The transaction ID, T, helps ensure that each job description (and hence permission certificate) is unique.
3. Central controller encrypts J′ using the party's public encryption key and sends the encrypted message to the party. Central controller sends
   M₀=E_{PKEA}(J′,_{SSKST}(PKE_{A},J′))
   to the party. The party's public key is included as part of the information that central forward a copy of a job description they controller 200 signs so a third party cannot received from central controller 200 to another party.
4. The party decrypts the message to retrieve J′, verifies central controller 200's signature, reads the request, and decides if he wants to release his party data. If he doesn't, then he stops the protocol here.
5. The party generates a message M containing the following information:
   A pre-defined string that states that he gives his permission to release his party data to the requester.
   A hash of the request H(J′). Note this is unique to this permission certificate since the transaction ID is unique to the job description.
   A string that states the details about how he wants her party data released whether or not he wishes to remain anonymous, etc.
6. The party signs the message, encrypts it using central controller 200's public encryption key and sends it to central controller 200. Hence, she sends
   M₁=E_{PKET}(M,S_{SKSA}(M))
   to central controller 200.
7. Central controller 200 decrypts the message to retrieve M, verifies the party's signature, and transmits the party's data to the requester.

Because the party signs the message that central controller 200 sent him in the first step, his signature will only work for the job description that central controller 200 sent him, Hence, central controller 200 cannot use the permission certificate for a different job description. This assumes, of course, that the request to release party data contains information unique to that request, such as a transaction ID number. Central controller 200 embeds the transaction ID in the request to release party data message.

In an alternative embodiment, central controller 200 could assign a different transaction ID to each request and party. Hence, two different parties cannot easily check that they are getting the same request by comparing transaction IDs.

The same protocol can be used in any other situation which also requires a permission certificate. For example, central controller 200 needs to obtain permission from a requester before releasing his requester data to a party.

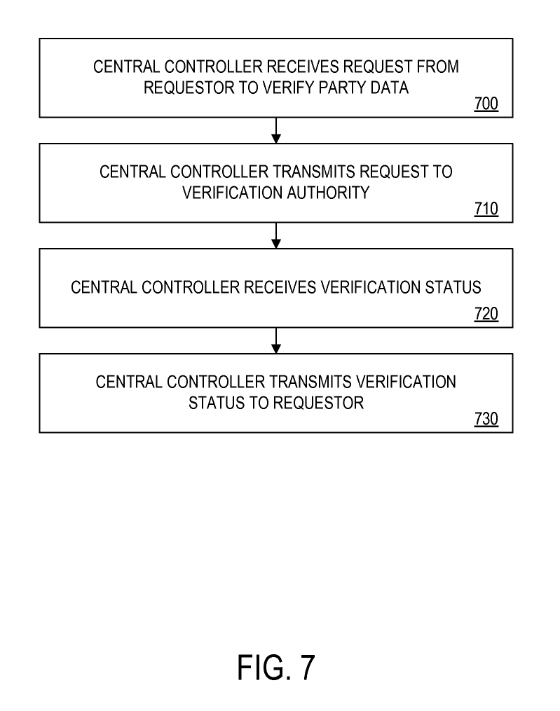

Returning to FIG. 5, central controller 200 can receive an authentication request to verify the authenticity of the origin, authorship, and/or integrity of party data or requester data (step 520). Upon receiving this request, central controller 200 verifies the data and transmits a verification status to the party or requester requesting data verification (step 520). Step 520 is described greater detail in connection with FIG. 7. Central controller 200 receives a verification request from a requester for verification of party data (step 700). As described above, this verification may include verifying the authenticity of any one of the origin, authorship, and integrity of the party data stored in databases 255.

In response, central controller 200 transmits a verification status request to a verification authority to verify the party data (step 710). For instance, in the employment services example, the party data to be verified may include a university from which a candidate received an advanced degree. In that case, central controller 200 could transmit a verification status request to the candidate's purported educational institution to verify that the candidate did, in fact, receive an advanced degree from that institution.

When central controller 200 receives a response to its request indicating the verification status of the party data, central controller 200 stores the verification status in verification database 270 (step 720), and transmits that verification status to the requester at requester terminal 400 (step 730).

The method shown in FIG. 7 could be adapted to verify requester data. In that case, central controller 200 receives a request from a party to verify requester data and transmits a request to a verification authority. When central controller 200 receives the verification status from the verification authority, it transmits the verification status to the party.

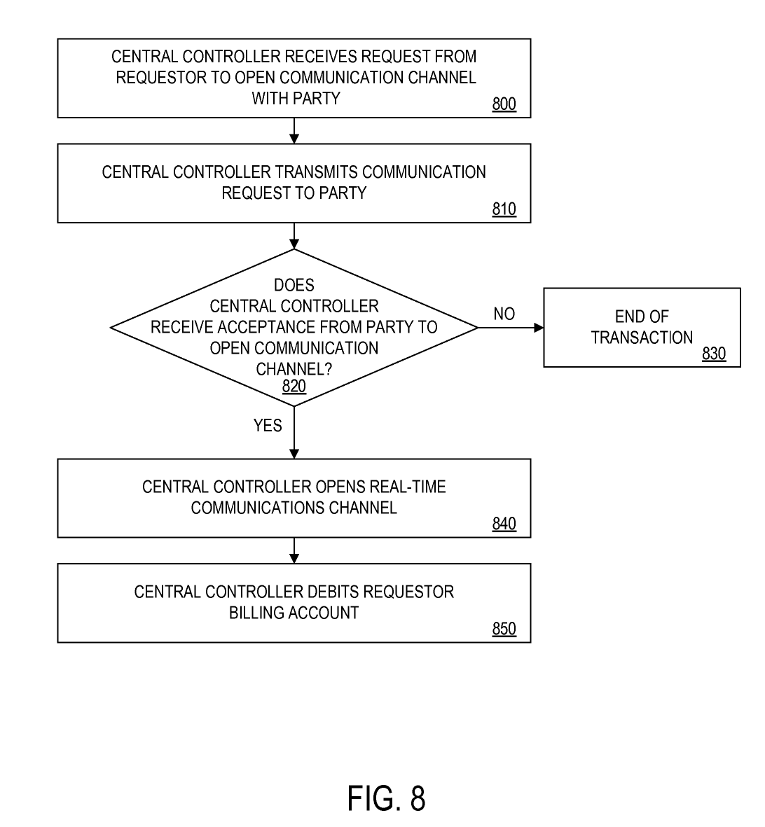

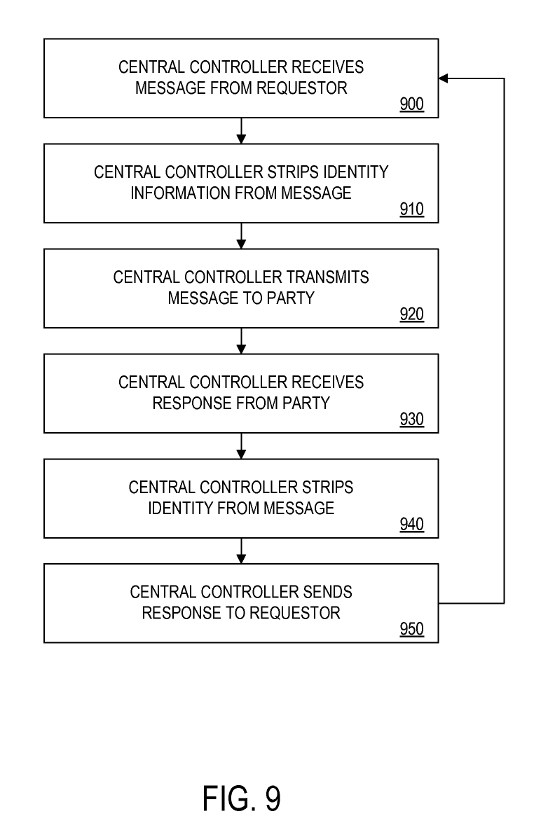

Returning to FIG. 5, central controller 200 can establish an anonymous communications channel between a party and requester (step 530). In this way, the party and the requester can reveal or request information to and from each other. As described above, the communications channel can be real-time or non-real-time. FIG. 8 shows a flow diagram illustrating one embodiment of a method for opening a communications channel between party terminal 300 and requester terminal 400 and FIG. 9 shows a flow diagram illustrating one embodiment of a method for managing the communication between party terminal 300 and requester terminal 400. After receiving a communications channel request from a requester to open a communications channel with a party (step 800), central controller 200 transmits a communication request to the party at party terminal 300 (step 810). Preferably, the communication request asks the party whether it agrees to engage in a real-time or non-real-time communication with the requester.

If central controller 200 receives a response indicating that the party does not agree to engage in communication with the requester (step 820), then central controller 200 does not open the communications channel and the transaction ends (step 830). If central controller 200 receives a response indicating that the party agrees to the request (step 820), central controller 200 opens a communications channel between party terminal 300 and requester terminal 400 (step 840). The communications channel can be set up as either a real-time or non-real-time connection including an audio system (i.e., a telephone system), an electronic messaging system, and a video communication system. In one embodiment, the communications channel includes a modification processor for modifying voice and/or video.

After opening the communications channel, central controller 200 debits the requestor's billing account stored in database 275 and transmits a bill to the requester (step 850). Central controller 200 could also collect payment from the requester using other payment methods including: on-file credit card, periodic statement billing, account debit, and digital cash. Further, in one embodiment, central controller 200 transmits payments to parties for party activities including: allowing central controller 200 to maintain party data in party data database 255, communicating with requesters, and releasing party data.

FIG. 9 illustrates a flow diagram of the method of step 530 for establishing a communications channel, in accordance with one embodiment of the invention. Central controller 200 receives a message from a requester addressed to a particular party by pseudonym (step 900). Central controller 200 processes the message to remove any information that would reveal the identity of the requester (step 910) in order to maintain the requestor's anonymity. Central controller 200 transmits the processed message to the party at party terminal 300 (step 920). Central controller 200 receives a response to the message from the party, removes any information that would reveal the identity of the party (step 940), and transmits the processed response to the requester (step 950).

Removing identity information may also include the use of voice and/or video modification processors instep 910 and 940. Steps 900-950 are repeated to allow multiple messages to pass between the party and the requester, while maintaining the anonymity of the party and requester. In one embodiment, central controller 200 debits the requester billing account according to the usage of the communications channel between the party and the requester (step not shown). Central controller 200 can measure usage of the communications channel using one of several methods, including: number of messages exchanged, time that central controller 200 maintains the communications channel, the requestor's status (i.e., premium customers pay less), and geographic location of party terminal 300 and/or requester terminal 400.

Central controller 200 collects payment for certain transactions performed. In accordance with one embodiment of the invention, central controller 200 transmits a bill to the requester at requester terminal 400 for each transaction and debits the requesters account (step 540), which is stored in database 275 of central, controller 200. In alternative embodiments, the payment scheme can be modified or varied to charge either the requester or the party or both for various transactions executed by system 100, and particularly central controller 200. In a further embodiment, the payment scheme involves paying the party for submitting information to central controller 200, opening a communications channel, and/or releasing party data to a requester. In one embodiment of the system, a party is paid each time he authorizes the release of his party data to a requester. Central controller 200 will monitor the transactions to ensure that parties do not release information to the same requester more than once in a given period of time.

As stated earlier, maintaining the anonymity of the party and requester can be important to their communications. For example, an employer may not want its competitors to know that it is looking to expand its staff because it may give them an advantage. An attacker may attempt to examine the message traffic coming in and out of central controller 200 to expose the identity of a user of the system. A way to prevent this type of attack is to use an anonymous mix protocol during, communication between a party or requester and central controller 200.

An anonymous mix uses a protocol to make it very difficult for anyone to trace the path of a message which passes through the mix. The anonymous mix takes outgoing messages from central controller 200 and randomly varies both the length of the message as well as the timing of its delivery. An incoming message of two hundred kilobytes, for example, might be expanded to three hundred kilobytes by adding random characters at the end. An attacker would thus be unable to correlate (by length of message) the incoming requester query with requests to release party data sent to the various parties. By adding a random time delay in the processing of incoming requests, central controller 200 also prevents an attacker from correlating (based on time) incoming requests with outgoing requests. An example of the anonymous protocol employed in the present invention is set forth below.

Notation and Conventions for this Protocol:

a. PKE_{PKU}(X) represents the public-key encryption of X under public key PKᵤ.

b. SIGN_{SKU}(X) represents the digital signature of X under private key SK_{U}.

c. E_{K0}} (X) represents the symmetric encryption of X under key K₀.

d. PK_{U} represents the public key of user U.

e. SK_{U} represents the private key of user U.

f. D_{U} represents the identification number of user U.

g. X,Y represents the concatenation of X with Y.

Keys Used in this Protocol:

a. PK_{M} is the anonymous mix public key.

b. ID_{B} is Bob's ID.

c. PK_{B} is Bob's public key.

d. SK_{B} is Bob's private key.

When Alice sends Bob a message through anonymous mix, the following steps could take place:

a. Alice wishes to send massacre T to Bob anonymously. She first forms:

K₀=a random session key.

P₀=an all-zero string of some random length.

X₀=PKE_{PKM}(K₀).

M₀=X₀,E_{K0}(ID_{B},P₀,T).
Alice then sends M₀ to the anonymous mix 180. Note that Alice may also have encrypted and digitally signed the message she's sending to Bob. This has no bearing at all on how the anonymous mix processes it. P₀ disguises the size of the message, making it difficult, or virtually impossible, to correlate incoming messages with outgoing messages.

b. The anonymous mix receives M₀. Using X₀, anonymous mix decodes the random session key K₀ using anonymous mix private key SK_{M} and then using K₀, ID_{B}, T and P₀ are decrypted. The anonymous mix looks up Bob's public key from ID_{B}, and then forms:
K₁=a random session key.
P₁=an all-zero string of some random length.
X₁=PKE_{PKB}(K₁).
M₁=X₁,E_{K1}(P₁,T)
   Anonymous mix waits some random amount of time before sending M₁ to Bob. During this time, it is processing many other messages, both sending and receiving them.

c. Bob receives M₁. He decrypts it using his private key, SK_{B} and recovers T. He then does whatever he needs to with T.

In order to make messages that pass through an intermediary anonymous mix anonymous, a large volume of messages coming in and out are reviewed. A random delay involved in forwarding those messages may also be required. Otherwise, it is possible for an opponent to watch messages going into and coming out of anonymous mix, using this information to determine the source and destination of each message. Similarly, messages must be encrypted to the anonymous mix, so that the messages can be decrypted and re-encrypted with a different key. Also, messages may need to be broken into many pieces or padded with large blocks of data, to avoid having message lengths give away information. Anonymous mix either knows everyone's public keys or their public keys are sent along with their identities. Every user is assumed to know anonymous mix's public keys. The anonymous mix, used in combination with encryption and digital signatures discussed earlier, provides a high level of anonymity for both parties and requesters.

Anonymity may also serve to prevent a requester and party from contacting each other outside the system in order to ensure that payment is received for bringing the two together. In this embodiment, central controller 200 forces anonymity by blinding one or both parties. The requester, for example, may not see the name of the party until the requestor's account has been debited.

FIGS. 8 and 9 illustrate a method in which a communications channel between a party and requester is established and managed by system 100 without either the party or the requester learning the other's identity. While FIGS. 8 and 9 illustrate methods in which central controller 200 establishes the communications channel at a requestor's request, in alternative embodiments, a communications channel can be established at a party's request. In that case, central controller 200 receives a request for a communications channel from party terminal 300, transmits the request to requester terminal 400, and establishes a communications channel in accordance with the requestor's response.

While the invention, as embodied and described in connection with system 100, can be applied to the employment search process, the invention can also be applied to a variety of other areas involving anonymous communications. For instance, system 100 can be used in connection with matchmaking (i.e., providing dating services). People, or “parties,” interested in dating can enter personal data, or “party data,” about themselves at party terminals 300. For each party, the party data may include the party's identity, the party's vital statistics, the party's background, and the party's interests. Central controller 200 and party terminals 300 receive and transmit the party data in the manner described above.

People, or “requesters,” who would like to find parties whose personal data satisfies their interests or tastes can enter a search request at requester terminal 400. In one embodiment, requesters enter data, or “requester data,” about themselves at request terminal 400, which encrypts and transmits the requester data to central controller 200. In addition, each requester enters, at request terminal 400, a search request specifying attributes about people that the requester would like to date. For instance, the search request may specify that the requester is interested in identifying men that are at least 6′ tall and are college-educated. Request terminal 400 encrypts the search request and transmits the encrypted search request to central controller 200 for processing, as described above.

In response to the search request, central controller 200 preferably transmits to requester terminal 400 the number of people found to satisfy the criteria in the request, as described above in connection with FIG. 6A. In the example given above, central controller 200 would transmit to requester terminal 400 the number of people who indicated that they are men, 6′ tall and college-educated, as revealed by party data database 255. Central controller 200 releases party data and requester data to the requester and parties, respectively, in the manner described above in connection with FIG. 6B. Central controller 200 can verify data, as described in connection with FIG. 7, and open a communications channel between a requester and a party, as described in connection with FIGS. 8 and 9. When central controller 200 opens the communications channel, the requester and the party can exchange adequate information about themselves to decide whether to agree to a date without subjecting themselves to any risk if either should decide not to agree to the date.

The employment search and dating services examples demonstrate how the invention can: allow a requester to search for parties meeting certain criteria, allow parties to control the release of information about themselves, and provide a communications channel between a requester and the parties while maintaining the anonymity of the parties and the requester from each other. The invention, however, is not limited to those types of applications. Other applications include finding and interviewing consultants or freelancers for a specific project, auditioning actors and actresses, seeking a merger partner, and engaging in various commerce-based applications in which controlled anonymity by any party would be beneficial.

The invention can be used in applications where the system establishes a communications channel between parties and authenticates information about the parties, while maintaining the anonymity of at least one of the parties. In one embodiment, system 100, as described above, could be used for such applications. This embodiment allows two parties to communicate while each party is ensured that the information being communicated is valid. For example, in the case of a “whistle-blowing” application (outlined below) an employer can be certain that the information he receives is from an employee within his organization. The methods illustrated by the flow diagrams of FIGS. 5-9 could be readily adapted for these applications.

By way of example, system 100 could be used as a “whistle-blowing” system to allow employees of a company to anonymously report legal and policy violations without risking retribution by the company's management. The employee reporting a violation would preferably enter, into party terminal 300, data about the violation and data that can be independently verified as originating from the employee claiming the violation. The employee is referred to hereafter as the “party” and the data entered into party terminal 300 is referred to hereafter as the “party data.” In one embodiment, the party data may include an employee identification number uniquely identifying each employee of the company. Party terminal 300 encrypts and transmits the party data to central controller 200, preferably in the manner described above.

A company representative, referred to as the “requester,” would use requester terminal 400 to access the party data stored in central controller 200. After accessing the party data about the violation, the requester could submit a request at requester terminal 400 to have some or all of the party data authenticated. For example, central controller 200 could verify that the party is, in fact, an employee of the company by comparing an employee identification number contained in the party data with a list of active company employee identification numbers. If the number matches, central controller 200 would transmit a response to requester terminal 400 confirming, that the party is an active employee of the company.

The requester, or the party, could enter a request into requester terminal 400, or party terminal 300, for central controller 200 to open a communications channel with the party, or the requester. Central controller 200 would open a communications channel, as described above in connection with FIGS. 8 and 9, to allow the party and the requester to communicate, while maintaining the party's anonymity. This would allow the employer to question the employee about details relating to the incident in question, without the employee revealing his identity.

In another example, system 100 could be used as a system to allow parties to remain anonymous while negotiating an agreement. For instance, criminals, or parole offenders, anonymously offer to turn themselves in, while negotiating favorable treatment. In this case, the criminals, or rule offenders, would represent the “parties” and law enforcement, or rule enforcers, would represent the “requesters.” In a preferred embodiment, a party would enter, at party terminal 300, information (“party data”) about his violation and data that can be independently verified as originating from the party claiming the violation. The party data can include the party's identity, which is preferably only used by system 100 for verification purposes. Party terminal 300 would encrypt and transmit the party data to central controller 200, in the manner described above. A requester would use requester terminal 400 to access the party data stored in central controller 200.

The requester could enter a request for authentication of the party data into requester terminal 300, which would transmit the request to central controller 200. Central controller 200 would ver y some or all of the party data, as described above, and transmit a verification status message to requester terminal 400. Upon request from either party terminal 300 or requester terminal 400, central controller can establish an anonymous communications channel with the other terminal, provided that the party and the requester agree to engage in the communications channel. As described above, this communications channel can be real-time or non-real-time.

Under the “plea bargaining” example, the invention allows the requester and the party to negotiate the terms of the party's sentence or punishment for committing the violation before the party reveals his identity. If negotiations fail, the party does not subject himself to any risk that the requester will learn his identity simply because he initiated communication. The requester, of course, can use whatever information the party revealed about himself during the course of the negotiation to learn the identity of the party.

Besides the whistle-blowing and plea bargaining examples, the invention also applies to other applications, such as authenticated phone-based tip lines and licensing negotiations where a licensee does not want to reveal the size of his company for fear of being charged more by the licensor.

In another example, some embodiments of the present invention relate to home viewing systems and more particularly, to systems and methods wherein payment is provided to a homeowner in exchange for allowing information about a home to be transmitted. At least one embodiment of the present invention allows for a homeowner to have a picture of a home that is not currently on the market displayed anonymously (e.g., in exchange for a payment).

Traditionally, a homeowner who is interested in selling a home uses a real estate broker to market and sell the home. The homeowner generally agrees to pay the real estate broker a fee equal to a percentage (generally 4%-7%) of the selling price of the home. In return, the real estate broker markets the home and shows the home to potential buyers. The real estate broker also conducts “open houses” that invite the public to visit and inspect the home.

Real estate brokers also offer a Multiple Listing Service (“MLS”) that lists all participating homes currently on the market in a given geographic area. Real estate brokers participating in the MLS are entitled to a commission for selling a home listed with the MLS even if the home is listed with another broker.

In addition, an individual looking to purchase a home often also solicits the assistance of a real estate broker. The real estate broker shows the individual a number of homes based on the individual's preferences. The individual's selection is limited to homes that are currently on the market to be sold. Thus, potential buyers do not have access to all the homes they may be interested in buying or viewing. The limited number of homes on the market also limits the ability of a real estate broker to determine the potential buyer's preferences when choosing a home.

An online real estate service is an alternative to a traditional real estate broker. The online real estate service lets a homeowner list a home for sale and encourages a potential buyer to use a Web site to search for a new home. Typical online real estate brokers require homeowners to pay a fee listing a home, and potential buyers may subscribe to the online service to access the homes for sale. An online real estate service may also offer virtual tours of homes for sale as well as details about the homes.

Generally, real estate services are directed only to homeowners who are interested in selling their homes, resulting in an untapped market for homes that are not for sale (and most homes are not on the market to be sold). Moreover, a homeowner who does not put his or her home on the market to be sold currently has no convenient way to gauge demand for his or her home. As a result, it may not be possible to determine how willing such a homeowner would be to sell his or her home if a potential buyer was found. In addition, a potential buyer may not be able to evaluate homes that are not on the market to be sold and express interest in those homes.

Some embodiments of the present invention provide for systems and methods wherein payment is provided to a homeowner in exchange for allowing information about a home to be transmitted. It is arranged for a homeowner who owns a home to receive compensation in exchange for allowing home information about the home to be transmitted. The compensation is based on compensation information associated with the home. It is further arranged for the home information to be transmitted to a viewer.

It is an object of at least one embodiment of the present invention to provide systems and methods for receiving a homeowner's agreement to allow a picture of a home to be transmitted (e.g., to a viewer such as a potential buyer). A payment, based on compensation information associated with the home, may be provided to the homeowner in exchange for the agreement. It is also an object of an embodiment of the present invention to provide systems and methods that enable a potential home buyer to view a home that is not for sale.

In accordance with one embodiment of the present invention, a homeowner, who may not wish to sell his or her home, allows a picture of his home to be displayed anonymously and remotely. The homeowner is compensated in exchange for allowing the picture of the home to be displayed. The compensation may comprise a payment that is based on information associated with the home (e.g., how many viewers view the picture of the home or the appraised value of the home).

According to some embodiments of the present invention, the viewer (e.g., a potential buyer) pays a fee for viewing the picture.

The following terms are used throughout the discussion of the following embodiments related to homeowners. For purposes of construction, such terms shall have the following meanings:

The term “homeowner” refers to any person or entity that owns, leases, or rents commercial, residential or other forms of property, including a homeowner who does not intend to sell his or her home.

The term “viewer” refers to a person, including a potential buyer, interested in remotely receiving information associated with homes, such as a picture of a home. Note that a viewer may use any device appropriate to receive the information about the home. For example, a viewer may use a telephone to “view” (i.e., listen to) a recording about a home.

The term “central authority” refers to any party that implements a remote home viewing system, including, for example, an Internet real estate broker or other Internet business (including, for example, service providers such as AMERICA ONLINE®).

The term “unlisted home” refers to a home that is not currently on the market to be sold.

The term “viewing fee” refers to a fee charged to viewers in exchange for viewing pictures of homes through the central authority.

The phrases “information about a home,” “information associated with a home,” “home information” and “compensation information” refer to any information associated with a home or a homeowner, including, by way of example only, a number of rooms in a home, the number square feet in a home, an appraised value of a home, a picture of a home, a level of interest a homeowner has in selling a home and a viewer's interest in purchasing a home.

The term “picture” refers any type of picture, including, for example, a drawing (including a computer-aided drawing), a photograph and video images.

The term “payment” refers to any compensation, such as a credit to a financial account and/or a reduction of a mortgage interest rate, provided to a homeowner in exchange for allowing home information to be transmitted and displayed to a remote viewer.

The term “home” refers to any residential, commercial, or undeveloped property, including, for example, a single family residence, a condominium apartment, a house boat or a recreational vehicle.

The following paragraphs illustrate the structural and operational aspects of the present invention. The structural aspects are illustrated first and are followed by discussions of the operational aspects.

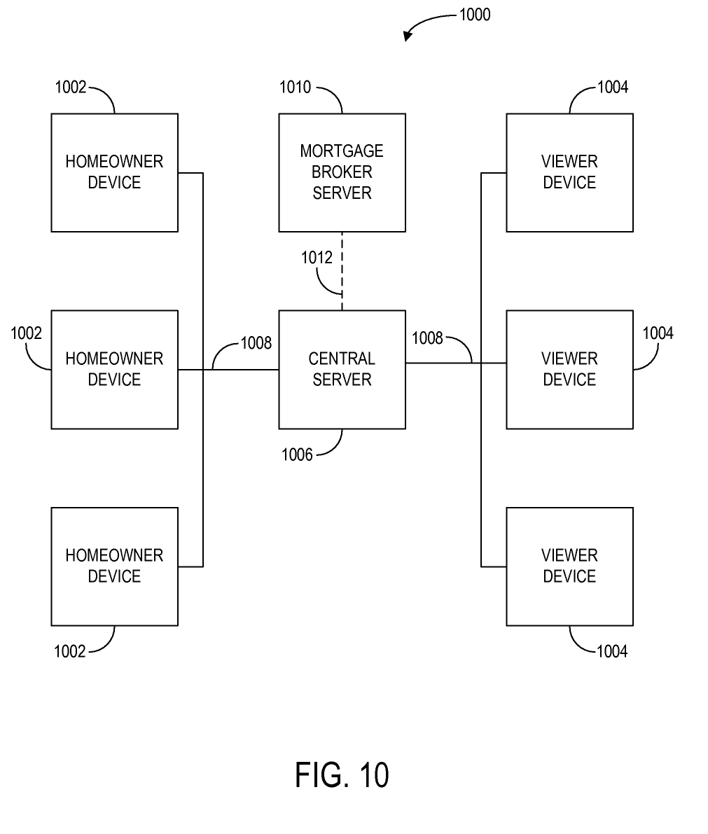

In terms of structure, reference is now made to FIG. 10 which is a block diagram of a remote home viewing system 1000 that may be used to: store home information about a home (such as a picture); determine a payment to a homeowner; transmit the home information to a remote viewer; collect a payment from the viewer for receiving the information; and/or distribute the determined payment to the homeowner. Although embodiments of the present invention are described herein as transmitting a picture of a home for display, it will be understood that other information about a home may be transmitted in addition to, or in place of, a picture.

The remote home viewing system 1000 includes a plurality of homeowner devices 1002 and a plurality of viewer devices 1004 communicating with a central “server” 1006 (i.e., any device that can perform some of the functions described herein) located at a central authority. Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

Although three homeowner devices 1002 and three viewer devices 1004 are illustrated in FIG. 10, it should be understood that any number of homeowner devices 1002 and viewer devices 1004 may be included in the remote home viewing system 1000. The homeowner devices 1002, viewer devices 1004 and the central server 1006 communicate via a communication network 1008, which may comprise, for example, a Local Area Network (LAN), a Wide Area Network (WAN), a Public Switched Telephone Network (PSTN) (e.g., when the “viewer” device is a telephone used to access information about a home), a cable or other television network (e.g., when the viewer device 1004 is a television or set-top box), a wireless network or an Internet Protocol (IP) network (e.g., the Internet, an intranet or an extranet). The homeowner devices 1002 and the viewer devices 1004 may include different types of devices, and/or devices that communicate with the central server 1006 through different networks.

In one embodiment, a mortgage broker server 1010 communicates with the central server 1006 through a data link 1012 (shown by a broken line). The central server 1006 may communicate with the mortgage broker server 1010, for example, to reduce a homeowner's mortgage interest rate in exchange for the homeowner's participation in the remote home viewing system 1000, as will be described.

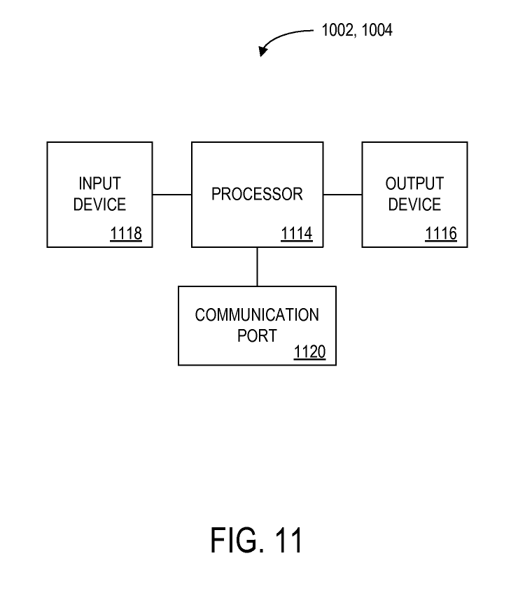

FIG. 11 is a block diagram of a homeowner device 1002 or a viewer device 1004 of FIG. 10 according to an embodiment of the present invention. Each homeowner device 1002 and viewer device 1004 comprise a processor 1114 in communication with an output device 1116, an input device 1118 and a communication port 1120. The output device 1116 may comprise, for example, a monitor that displays instructions or information about a home for viewing by the user. The input device 1118 may comprise, for example, a scanner, an input port, keyboard or mouse. The communication port 1120 is adapted to exchange information with the central server 1006.

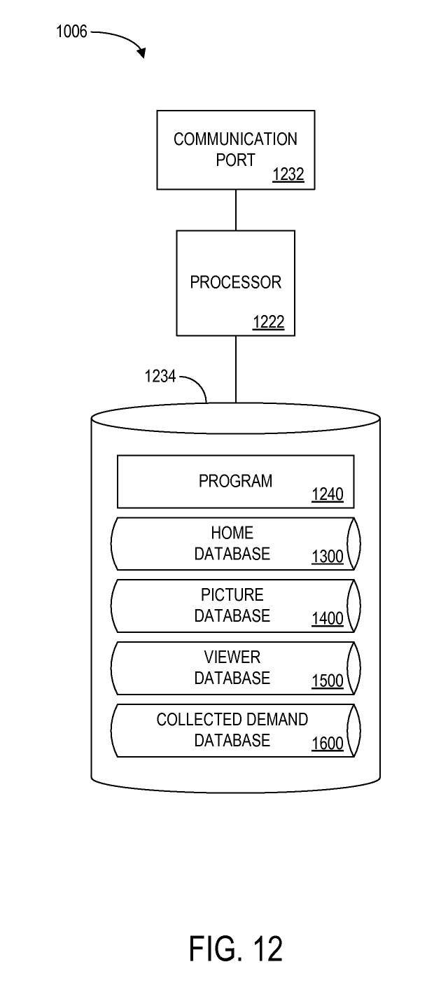

FIG. 12 is a block diagram of the central server 1006 shown in FIG. 10 according to an embodiment of the present invention. The central server 1006 may be any computing device that can communicate with one or more homeowner devices 1002 and/or one or more viewer devices 1004. The central server 1006 comprises a processor 1222, such as one or more INTEL® Pentium microprocessors.

The processor 1222 is coupled to a communication port 1232, through which the processor 1222 communicates with the viewer devices 1004 and/or the homeowner devices 1002.

The processor 1222 is also coupled to a data storage device 1234. The data storage device 1234 comprises an appropriate combination of magnetic, optical and/or semiconductor memory, and may include Random Access Memory (RAM), Read-Only Memory (ROM) and/or a hard disk. The processor 1222 and the data storage device 1234 may be (i) located entirely within a single computer or other computing device or (ii) connected to each other by a remote communication medium, such as a serial port cable, telephone line or radio frequency transceiver. In one embodiment, the central server 1006 may comprise one or more computers that are connected to a remote server computer for maintaining databases.

The data storage device 1234 stores a program 1240 for controlling the processor 1222. The processor 1222 executes instructions of the program 1240, and thereby operates in accordance with the present invention. The program 1240 is adapted to be executed by a processor and may be stored in a compressed, uncompiled and/or encrypted format. The program 1240 could also include program elements, such as an operating system, a database management system and “device drivers” that let the processor 1222 communicate with various devices. Appropriate device drivers and other program elements are known to those skilled in the art, and are not described in detail herein.

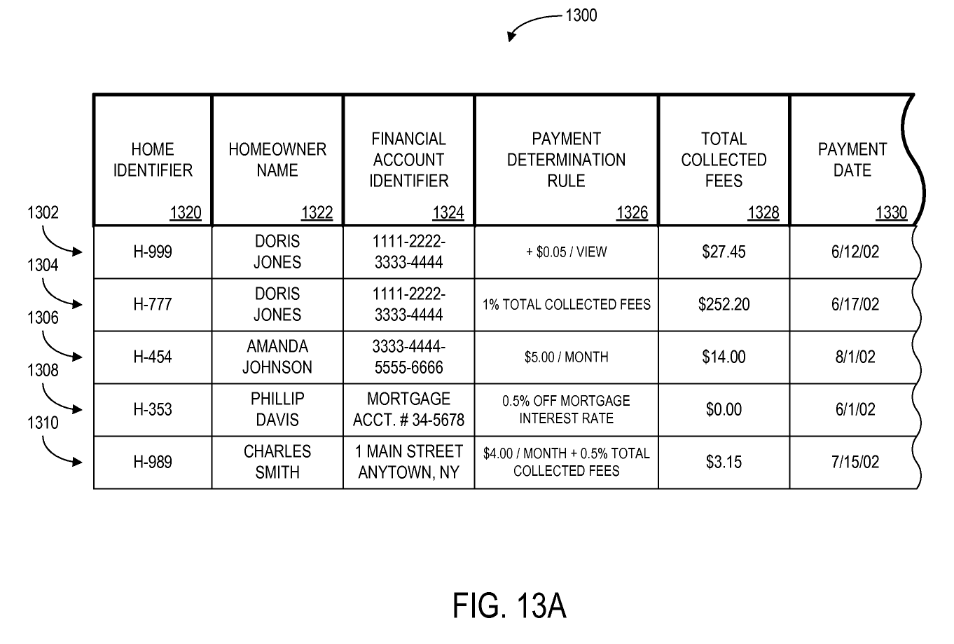

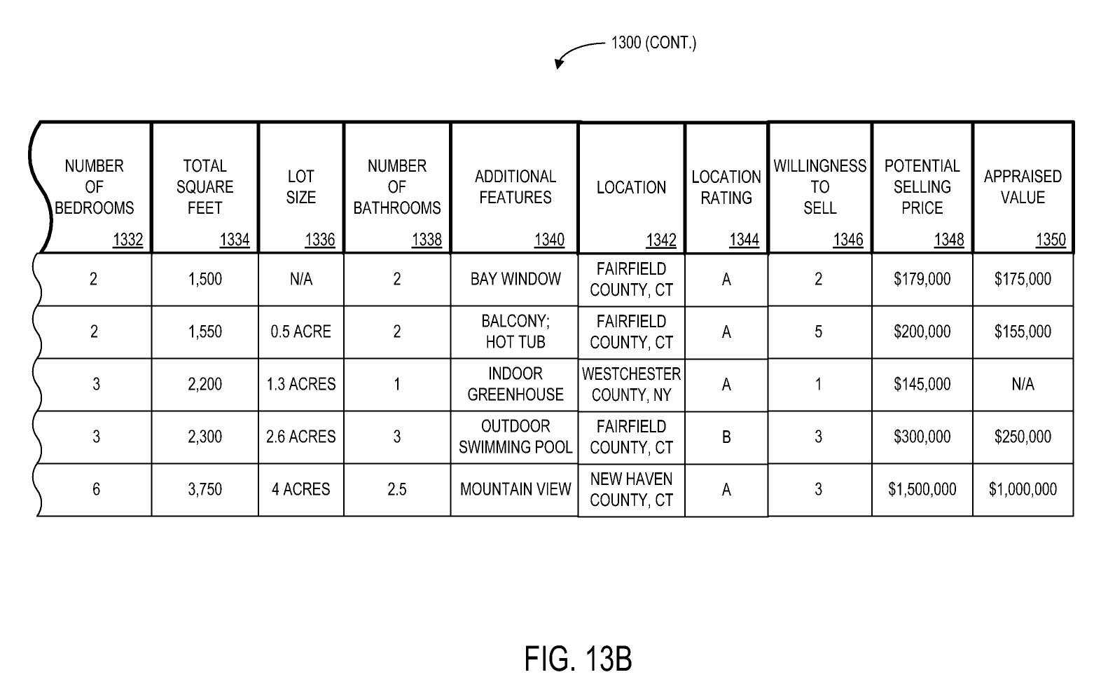

The data storage device 1234 also stores (i) a home database 1300, (ii) a picture database 1400, (iii) a viewer database 1500, and (iv) a collected demand database 1600. The databases 1300, 1400, 1500, 1600 are described in detail below and are depicted with entries in the accompanying FIGS. 13A-16. As will be understood by those skilled in the art, the schematic illustrations and accompanying descriptions of the databases presented herein are merely exemplary arrangements for stored representations of information. Any number of other arrangements may be employed besides those suggested by the tables shown. Similarly, the illustrated entries of the databases merely represent exemplary information, and those skilled in the art will understand that the content of these entries will vary.

The home database 1300 maintains a record of each home in the remote home viewing system 1000, including, for example, the homeowner's name, a payment determination rule and a financial account identifier associated with each homeowner. The financial account identifier may be associated with, for example, a credit card account to which a payment can be credited. The financial account identifier may also comprise, for example, a debit card account number, a checking account number, a street address to which a check may be mailed, a mortgage account number or information associated with an electronic currency protocol. The information from this database may also be used to determine a payment amount to provide to the homeowner in exchange for allowing a picture of his or her home to be posted.

The home database 1300 also stores information about each home, including, for example, the number of bedrooms and the appraised value of the home. Such information can be used, for example, by the central authority when trying to narrow a viewer's search (e.g., a viewer may be interested only in homes with at least two bedrooms).

The picture database 1400 maintains a record for each picture of a home available through the remote home viewing system 1000. Each record may include a picture file (or a link to a picture file), a fee for viewing the picture, and a number of times the picture has been viewed by a viewer or viewers.

The viewer database 1500 maintains a record of each viewer participating in the remote home viewing system 1000, including a financial account identifier corresponding to the viewer. The financial account identifier may identify an account from which a viewing fee can be debited, and may comprise any of the types of information described with respect to the homeowner's financial account identifier. The viewer database 1500 also tracks the fees owed by a viewer for viewing pictures of homes via the remote home viewing system 1000.

The collected demand database 1600 maintains a record of viewer interest in a home. The collected demand database 1600 may, in one embodiment, be accessed by a homeowner to gauge the demand for the homeowner's home. When expressing interest in a given home, a viewer may enter viewer information, such as whether the viewer is pre-approved for a mortgage and the price the viewer might be willing to pay for the home. The central authority measures the viewer's level of interest, perhaps rates it, and uses it to determine an overall “demand” for the home (e.g., whether there is a lot of serious interest in purchasing the home at a reasonable price). Note that a viewer's level of interest may be automatically determined by the central authority (e.g., by measuring the number of pictures viewed by a viewer, or the length of time a viewer spends looking at one or more pictures).

The present invention provides a remote home viewing system 1000 that encourages a homeowner, who may not be interested in selling his or her home, to display a picture of the home remotely and anonymously in exchange for receiving a payment. The payment provided to the homeowner is based on compensation information associated with the home. Such information may include, for example, (i) the number of viewers that view the picture of the home, (ii) an appraised value of the home, (iii) the location of the home, (iv) the expected interest of viewers in the home, (v) a level of anonymity maintained with respect to the homeowner or the home, and/or (vi) the current market price of the home. In one embodiment of the present invention, the payment is periodic (e.g., monthly). Note that the central authority may be, for example, (i) a real estate broker for not-for-sale homes only, (ii) a real estate broker for both not-for-sale homes and for-sale homes (e.g., homes that are currently on the market to be sold), or (iii) any other entity.

According to an embodiment of the present invention, the processor 1222, in accordance with the program 1240, arranges for a homeowner to receive compensation in exchange for allowing home information to be transmitted, the compensation being based on compensation information associated with the home. The processor 1222 also arranges for the home information to be transmitted to a viewer.

For example, the processor 1222 may, according to an embodiment of the present invention, receive information from a homeowner who wishes to anonymously display a picture of his or her home (e.g., without disclosing his or her name and/or address) in return for a payment determined in accordance with a payment determination rule agreed upon between the homeowner and the central authority. The processor 1222 stores information regarding the homeowner and information relating to the homeowner's home in the home database 1300 and/or the picture database 1400. The processor 1222 further transmits the picture, in response to a request from a viewer, to the viewer for a predetermined viewing fee.

The processor 1222 may also collect a payment from the viewer. The payment may be collected by, for example, debiting or charging a financial account associated with the viewer. The processor 1222 can also credit homeowners' financial account based on the appropriate payment determination rule.

The following paragraphs describe an embodiment of the home database 1300. Of course, many changes and alterations may be made to the home database 1300, as well as the other databases described herein, to effectuate certain functionality depending on particular design and implementation details. Such changes and alterations will be apparent to those skilled in the art of computer programming and database management system design and implementation.

Referring now to FIG. 13A and FIG. 13B, a table represents a tabular embodiment of the home database 1300. The table 1300 includes entries 1302, 1304, 1306, 1308, 1310 each defining a home in the remote home viewing system 1000 (FIG. 10). Those skilled in the art will understand that the table 1300, as well as the other tables described herein, may include any number of entries and may be divided into any other number of tables. Moreover, the tables may be stored on a computer readable medium as data (accessible by a program executable on a data processing system) organized according to a data structure that includes data objects (e.g., any type of data) accessible from other data objects.

The table 1300 also defines fields for each of the entries 1302, 1304, 1306, 1308, 1310. The fields specify: a home identifier 1320; a homeowner name 1322; a financial account identifier 1324; a payment determination rule 1326; total collected fees 1328; a payment date 1330; a number of bedrooms 1332; total square feet 1334; a lot size 1336; a number of bathrooms 1338; additional features 1340; a location 1342; a location rating 1344; a willingness to sell 1346; a potential selling price 1348; and an appraised value 1350.

When a homeowner agrees to allow information associated with his or her home to be transmitted to viewers, a home identifier 1320 uniquely identifying the home is generated and assigned to the home. A new record is created in the home database 1300 and information about the homeowner (e.g., the homeowner name 1322, financial account identifier 1324 and payment determination rule 1326) is stored in the record in association with the home identifier 1320.

Information about the home (such as the number of bedrooms 1332, the total square feet 1334, the lot size 1336, the number of bathrooms 1338) is also stored in the record associated with the home identifier 1320. Additional features 1340 of the home (e.g., whether the home has a pool) are also stored in the home database 1300 along with location 1342 information and a location rating 1344 (e.g., a rating from A to C reflecting the quality of the location of the home). Of course, the location rating may not be stored in the home database 1300 but may instead be stored in a separate database (e.g., a database correlating zip codes with location ratings), if desired.

Information about the value of the home (e.g., the potential selling price 1348 and the appraised value 1350 of the home) may also be stored in the home database 1300 along with the homeowner's willingness to sell 1346 the home (e.g., a rating from 1 to 5 reflecting how willing the homeowner would be to sell the home at the potential selling price 1348). The willingness to sell rating may be submitted by the homeowner or assigned by the central system (e.g. based on how close the potential selling price is to the appraised value).

In addition to information about the homeowner and information about the home, the home database 1300 may be used to store other information that may determine the amount of payment that the homeowner will receive. For example, the home database 1300 may store the total collected fees 1328 (e.g., the total amount of fees paid by viewers to receive information about that home) and a payment date 1330 (e.g., a date on which the central authority will provide the appropriate payment to the homeowner). For example, as shown in record 1304 of FIG. 13A, “Doris Jones” is to receive $2.52 on Jun. 17, 2002 (i.e., 1% of $252.20).

The payment due to the homeowner from the central authority may be credited to a financial account defined by the financial account identifier 1324. For example, with regard to record 1302, Doris Jones will receive a payment in accordance with a payment determination rule 1326 (i.e., she will receive $0.05 for each view of a picture of her home) that will be paid on “Jun. 12, 2002” to a financial account defined by the financial account identifier 1324 of “1111-2222-3333-4444.” Note that when the payment is made to Doris Jones, the total collected fees 1328 may be reset to $0.00. Note also that Doris Jones has two homes listed (i.e., homes associated with the home identifiers 1320 of “H-999” and “H-777”).

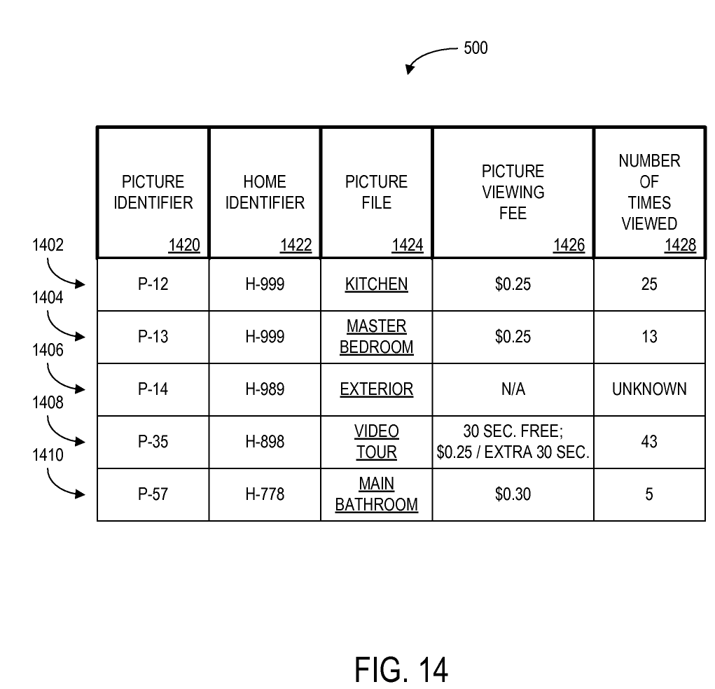

Referring now to FIG. 14, a table represents a tabular embodiment of the picture database 1400. The table 1400 includes entries 1402, 1404, 1406, 1408, and 1410 each defining a picture of a home in the remote home viewing system 1000. Those skilled in the art will understand that the table 1400 may include any number of entries. The table 1400 also defines fields for each of the entries 1402, 1404, 1406, 1408, and 1410. The fields specify: a picture identifier 1420 that uniquely identifies a picture of the home; the home identifier 1422 (e.g., the same home identifier 1320 stored in the home database 1300); a picture file 1424 containing data comprising (or a filename or filepath of) a picture of the home; a picture viewing fee 1426 defining a fee a viewer is required to pay in order to view the picture associated with the picture identifier 1420; and a total number of times viewed 1428 indicating the number of times viewers have viewed the picture.

For example, in table 1400, record 1402 contains a stored picture file 1424 of the kitchen of a home having a home identifier 1422 “H-999.” Furthermore, the picture viewing fee 1426 charged to a viewer is “$0.25” for each view. The number of times the picture of the kitchen was viewed is “25.” Note that some pictures may be available to a viewer without a fee (e.g., as shown in record 1406).

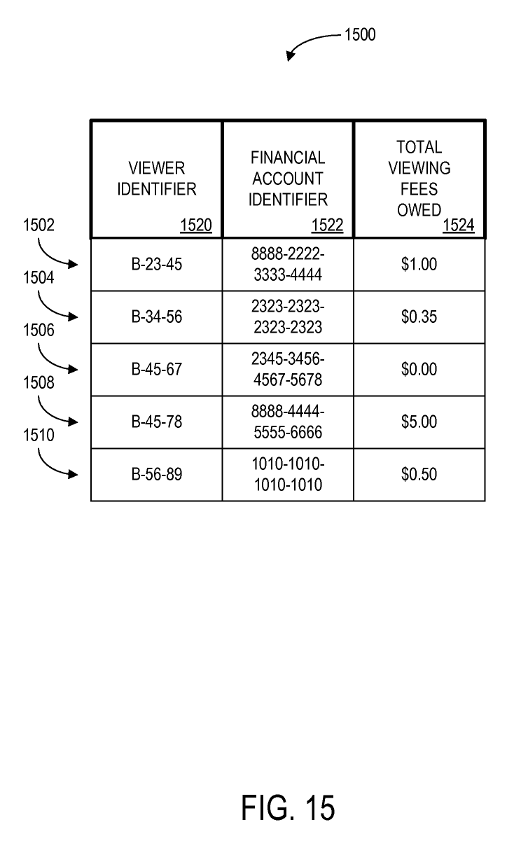

Referring now to FIG. 15, a table represents a tabular embodiment of the viewer database 1500. The table 1500 includes entries 1502, 1504, 1506, 1508, 1510 each defining a viewer participating in the remote home viewing system 1000. Those skilled in the art will understand that the table 1500 may include any number of entries. The table 1500 also defines fields for each of the entries 1502, 1504, 1506, 1508, 1510. The fields specify: a viewer identifier 1520; a financial account identifier 1522 defining a financial account associated with the viewer; and a total viewing fees owed 1524 indicating the sum of the viewing fees owed by the viewer to the remote home viewing system 1000. Note that after the viewer pays the appropriate total viewing fees owed 1524, the total viewing fees owed 1524 may be set to $0.00 (e.g., as shown in record 1506).

The following paragraphs describe an embodiment of the collected demand database 1600. The collected demand database 1600 may be used in the present invention to store records of viewer interest in specific homes. According to an embodiment of the present invention, the collected demand database 1600 can be accessed by a homeowner to gauge the demand for his or her home.

In particular, viewers transmit information to the central system 1006 regarding their interest in a specific home. Such information may include, for example: (i) whether or not the viewer is approved for a mortgage; (ii) the mortgage amount approved for the viewer; or (iii) a price the viewer may be willing to offer for the home. Such information may be used by the central system or the homeowner to determine the viewer's overall interest in a home.

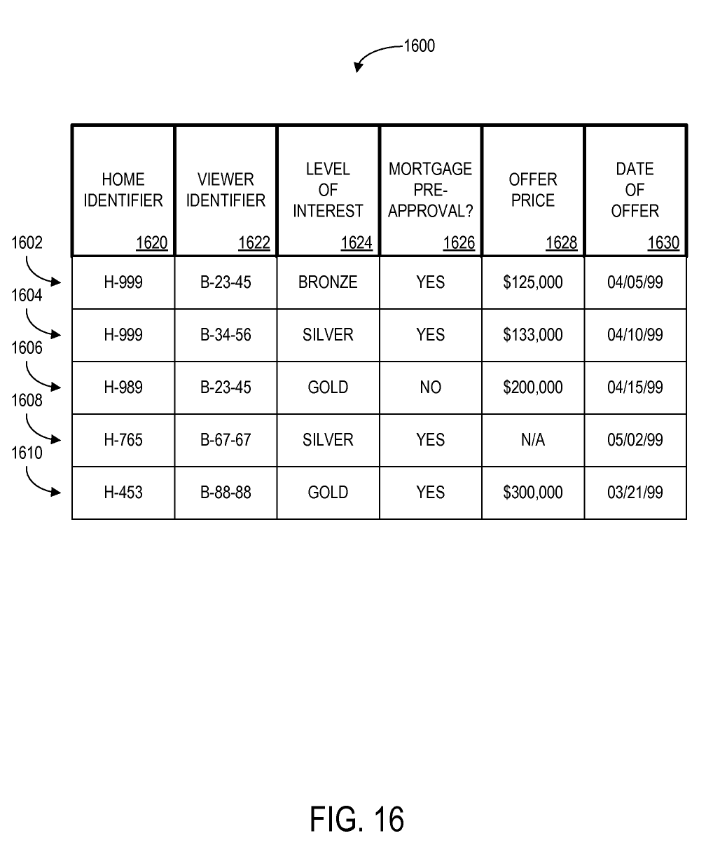

Referring now to FIG. 16, a table represents a tabular embodiment of the collected demand database 1600. The table 1600 includes entries 1602, 1604, 1606, 1608, 1610 each defining a viewer's interest in or “demand for” a particular home. Those skilled in the art will understand that the table 1600 may include any number of entries. The table 1600 also defines fields for each of the entries 1602, 1604, 1606, 1608, 1610. The fields specify: the home identifier 1620 (e.g., corresponding to the home identifier 1320 stored in the home database 1300); the viewer identifier 1622 (e.g., corresponding to the viewer identifier 1520 in the viewer database 1500); a level of interest 1624 reflecting a level of interest the viewer has expressed in the home; a mortgage pre-approval 1626 indicating if the viewer has been pre-approved for a mortgage, as indicated by the viewer or determined by the system; an offer price 1628 indicating the price the viewer may be willing to pay for the home; and a date of offer 1630 indicating the date on which the offer was received from the viewer.

The level of interest 1624 entries are depicted as either “Bronze,” “Silver,” or “Gold.” Of course, another format may be used to indicate the level of interest a viewer expresses in a home. The level of interest may be, for example: (i) directly specified by the viewer (e.g., selected from a menu of available levels of interest); or (ii) assigned by the central server 1006. If the level of interest is assigned by the central server 1006, it may be assigned based on, for example: (i) how many pictures of the home the viewer viewed; (ii) the length of time the viewer spent viewing the pictures; (iii) how closely the offer price 1628 matches the appraised value 1350 or the potential selling price 1348 of the home; (iv) whether the viewer sends a request for more information (e.g., by e-mail) to the central server; and/or (v) whether the viewer is pre-approved for an appropriate mortgage (e.g., whether the pre-approved mortgage amount is at least equal to the appraised value 1350 of the home). Whether or not the viewer is pre-approved for a mortgage may be stored based on an indication by the viewer. According to one embodiment of the present invention, the central server 1006 verifies that the viewer is in fact pre-approved for a mortgage by communicating with the mortgage broker server 1010. In another embodiment of the present invention, the central server 1006 may be operated by a mortgage broker rather than, or in conjunction with, a real estate broker and may pre-approve the viewer for a mortgage when the viewer submits an offer to the central server 1006. Additionally, the collected demand database 1600 may further store the mortgage amount approved for the viewer.

For example in record 1602, the viewer having a viewer identifier 1622 of “B-23-45” has submitted an offer price 1628 of “$125,000” on “Apr. 5, 1999.” Viewer “B-23-45” is pre-approved for a mortgage and has shown a level of interest 1624 of “bronze.” The level of interest 1624 may be indicated in a number of ways, e.g., a numeric scale from one to ten with ten being the most interested and one being the least interested. In the embodiment shown in table 1600, “Gold,” “Silver” and “Bronze” are used to define a viewer's interest, with “Gold” being the most interested and “Bronze” being the least interested.

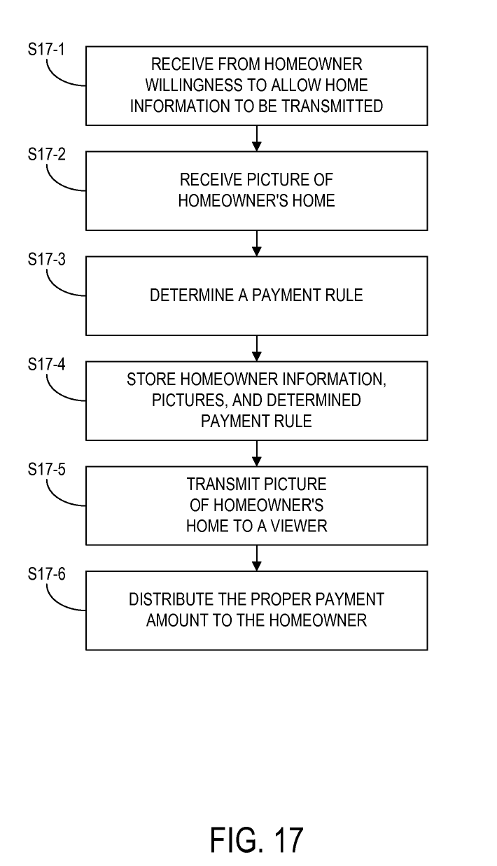

The aforementioned described structural aspects and corresponding components of embodiments of the present invention. Accordingly, it should be understood that the homeowner device 1002 and viewer device 1004 of the remote home viewing system 1000 shown in FIGS. 10-12 and the database tables illustrated in FIGS. 13A-16 may operate and function together. The flowcharts depicted in FIGS. 17-23B, described below, illustrate how such structures operate together according to embodiments of the present invention. In particular, described below are the steps carried out by the remote home viewing system 1000 to display pictures of a homeowner's home to a viewer via a network, such as the Internet, and provide compensation to the homeowner in accordance with a payment determination rule.

FIG. 17 is a flowchart that illustrates the steps of a process performed by a data processing system, such as remote home viewing system 1000, for receiving and transmitting information associated with a homeowner's home according to an embodiment of the present invention. The computer programming necessary to carry out many of the functions stated below, including those described with respect to the flowcharts, will be readily apparent to those skilled in the art of computer programming.

Processing starts at step S17-1, where the central server 1006 receives from a homeowner a willingness to allow home information (e.g., a picture of the home) to be transmitted. As previously described, the homeowner communicates with the central server 1006 via a homeowner device 1002 to accept an offer to display pictures of the homeowner's home. According to other embodiments of the present invention, the homeowner can communicate with the central server 1006 in other ways, such as by using a telephone, a facsimile machine, an e-mail message or regular mail service.

Thereafter, processing proceeds to steps S17-2 and S17-3, where the central server 1006 receives a picture or pictures of the homeowner's home and determines a payment rule based on information associated with the homeowner's home. Determining the payment rule may comprise, for example, retrieving the payment rule used by the system 1000 from a database. At step S17-4, the central server 1006 stores the homeowner information and the determined payment rule in the home database 1300. In addition, the picture or pictures of the homeowner's home are stored in the picture database 1400. The homeowner may submit pictures of his home or the system 1000 may send a person out to the home to take appropriate pictures.

At step S17-5, the central server 1006 transmits the picture or pictures of the homeowner's home to a viewer in response to a request by the viewer to view the pictures via a viewer device 1004. At step S17-6, the proper compensation or payment, as defined by the payment determination rule 1326 stored in the home database 1300, is distributed to the homeowner.

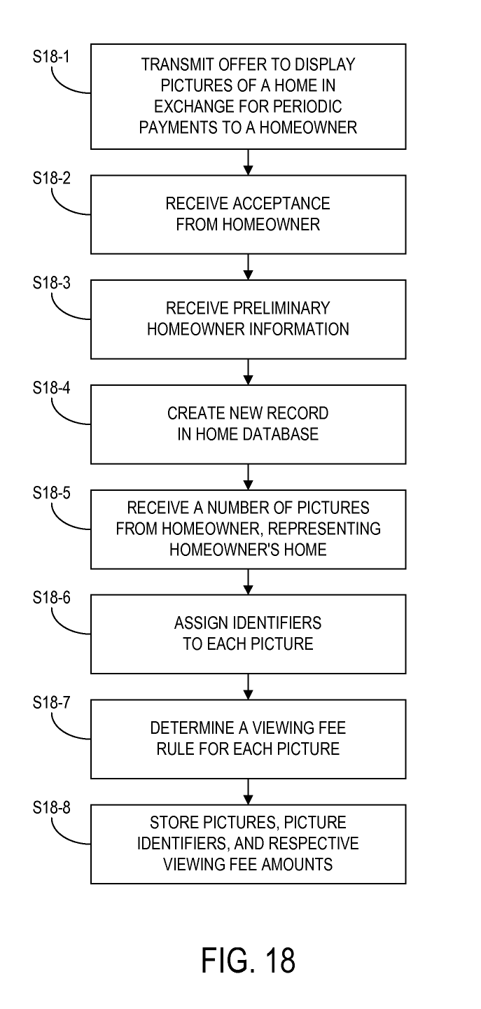

FIG. 18 is a flowchart that illustrates the steps of a process performed by a data processing system, such as remote home viewing system 1000, for storing a homeowner's home records in the home database 1300 according to an embodiment of the present invention.

Processing starts at step S18-1, where the central server 1006 transmits an offer, including a payment determination rule, to display pictures of a homeowner's home in exchange for a payment (e.g., a periodic payment). The central server 1006 may contact a homeowner using, for example, an e-mail solicitation, a direct mailing letter or an advertisement on another Web site. For example, the central authority can place a banner on a Web site that says, “Earn up to $20 a month for posting anonymous video images of your home at our Web site.” At step S18-2, the central server 1006 receives an indication from the homeowner that the homeowner is willing to allow information about the home to be transmitted to viewers. Thereafter, processing proceeds to step S18-3, where the processor 1222 of the central server 1006 receives preliminary homeowner information such as homeowner's name, address and a financial account identifier associated with the homeowner. The central server 1006 may then receive information about the home from the homeowner. This information may include, for example, features of the home such as the date the home was built, the style, the number of bedrooms, the number of bathrooms, the lot size (e.g., the number of acres of land), and any distinguishing features. When the central server 1006 receives enough information about the homeowner's home, an appropriate payment determination rule can be established.

According to one embodiment, fees collected from viewers (less a percentage taken by the central authority) are converted into a periodic payment distributed to the homeowner. The terms of the agreement may involve, for example: (i) a one-time or periodic payment based on information associated with the home; (ii) a periodic payment amount based on the number of times a viewer receives information about the home; and (iii) a payment based on a predetermined percentage of the total amount of viewing fees collected. Further, the amount of the payment may be determined by, for example: (i) the popularity of the area of the home (e.g., based on a zip code, distance from a city or school district); (ii) a predicted level of interest in the home based on its market value, neighborhood, condition, etc.; or (iii) a number of people who look at photographs and/or video images of the home displayed on the site.

In another embodiment, the amount of the payment may be based on an appraised price of the home. For instance, the home may be appraised by an appraiser (and verified by the central authority) when information about the home is entered into the central server 1006. The central server 1006 may further require the homeowner to name a potential selling price at which he or she would sell the home. The amount of the periodic payment may be determined by how close the named price is to the appraiser's price (e.g., the periodic payment is larger if the homeowner sets a potential selling price close to the appraised price). The central authority then enters the homeowner's name into the home database 1300. In such an embodiment, the homeowner may pay a penalty if he or she rejects an offer to purchase the home that is at least equal to the potential selling price.

At step S18-4, the processor 1222 creates a new record in the home database 1300 that includes the preliminary homeowner information. The processor 1222 assigns a unique identifier to the home and stores the identifier in the home identifier 1320 field of the home database 1300. A payment date 1330 may also be stored in the home database 1300 (e.g., the date on which the central authority will provide a payment to the homeowner).

At step S18-5, the processor 1222 receives one or more pictures of the homeowner's home. The central authority may obtain pictures of the homeowner's home by, for example: (i) arranging to take photographs or video images of the home; (ii) receiving photographs or video images of the home taken by the homeowner or anyone other than the central authority; and/or (iii) receiving blueprints of the home submitted by the homeowner and creating computer-aided drawings (e.g., two or three dimensional drawings).

At step S18-6, the processor 1222 generates and assigns a picture identifier 1420 to each picture to be stored in the picture database 1400. At step S18-7, the processor 1222 determines a picture viewing fee 1426 for each picture and stores the amount in the picture database 1400. For example, in record 1402, the fee to view the picture of the “kitchen” is “$0.25” for each view. In record 1408, the stored picture is a video image “tour” and the picture viewing fee 1426 is determined by the duration that the viewer views the video images. Specifically, the first “30 seconds” of video images is free and each subsequent “30 seconds” of video images costs “$0.25.” At step S18-8, the processor 1222 of the central server 1006 stores the picture identifiers 1420 and the respective viewing fees 1426 in the picture database 1400.

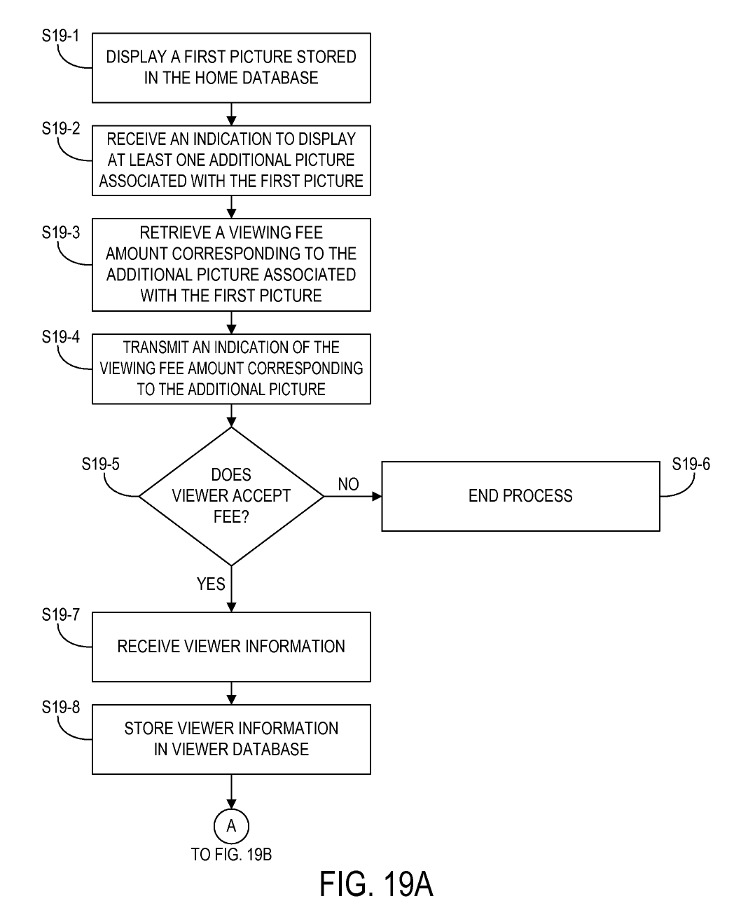

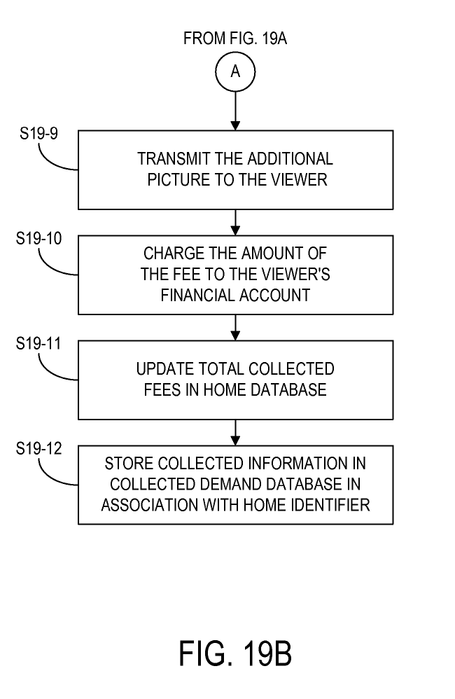

FIGS. 19A-19B are a flowchart that illustrates the steps of a process performed by a data processing system, such as remote home viewing system 1000, for displaying pictures stored in the picture database 1400. This illustrated embodiment is one wherein a standard amount of information is provided to a viewer (e.g., an exterior picture along with some general information about the home) without charge, but additional pictures cost an additional fee to view. If a viewer is interested in seeing more pictures of a particular home, he or she can select the picture (e.g., by using a mouse to “click” on a thumbnail picture or link). The central server 1006 displays to the viewer the associated fees for viewing the pictures, and the viewer can then indicate one or more of the additional pictures. According to another embodiment, the viewer can provide payment for a session of viewing pictures viewed, or can pay a fee to view a batch of pictures instead of paying for each single picture viewed.

According to an embodiment of the present invention, a viewer can initially select any picture in the home (e.g., a picture of the kitchen), and that first picture is free. If the viewer desires to see more pictures of the same home, then the viewer is charged for the additional pictures. The viewer, in this embodiment, essentially must reach/exceed a threshold level of interest before the viewer is charged any fee. The threshold may comprise, for example, a length of time a picture (including video images) is viewed, a predetermined number of pictures viewed, a predetermined picture viewed, or a particular type of picture (e.g., an interior picture) viewed. Once the remote home viewing system 1000 determines that the viewer has reached the threshold level of interest, additional pictures may require a viewing fee.

Processing starts at step S19-1 where the processor 1222 transmits information associated with a first picture stored in the picture file 1424 of the picture database 1400 to the viewer device 1004 (that is, the processor 1222 “arranges” for the picture to be displayed via the viewer device 1004). At step S19-2, the processor 1222 receives an indication from the viewer device 1004 requesting at least one additional picture from the picture database 1400 associated with the first picture. Accordingly, the processor 1222 retrieves a picture viewing fee 1426 associated with the requested picture from the picture database 1400 at step S19-3. At step S19-4, the processor 1222 transmits the viewing fee amount to the viewer.

The viewing fee for the pictures may be, for example: (i) constant for each picture; (ii) variable depending on how many pictures of the same home have already been viewed; or (iii) variable depending on the popularity of the home (e.g., how many other viewers have viewed pictures of the home). In one embodiment, different viewing fees are charged for different pictures of a not-for-sale home. For example, the kitchen picture may cost more than the bathroom picture. Alternately, the pictures may have the same viewing fee, however the more pictures a viewer wants to view, the more expensive the pictures become. For example, after the initial free picture of the exterior of the home, the viewer pays $0.50 to see the foyer. If the viewer wants to see another room, then he pays $0.75. The next room is still more expensive, etc. Alternatively, the pictures could become less expensive as they are viewed. In one embodiment a display of “thumbnail” pictures of the home may be displayed for no charge, but larger prints of each of the thumbnail-sized pictures require a fee to be viewed.

In another embodiment, a viewer pays a viewing fee to see a level of pictures rather than a specific picture. Pictures may be given levels when they are received from the homeowner and are stored in the picture database 1400 in a particular “level.” Different viewing fees are charged for viewing different levels. For example, the system could contain only two levels: a “free” level and a “viewing fee required” level. The free level may consist of, for example, an exterior picture of the home and descriptive information about the home. The viewing fee required level may consist of, for example, more detailed pictures of the home.

In another embodiment, the viewing fee a viewer is charged to view pictures of a homeowner's home may comprise an agreement to display pictures of his own home, e.g., “Pay a viewing fee to see more pictures of this home, OR view them for free in exchange for pictures of YOUR home!”

At step S19-5, if the viewer does not accept the viewing fee amount, the viewing process is ended as shown in step S19-6. If the viewing fee is accepted, the viewer provides viewer information that is received by the processor 1222, as shown in step S19-7. For example, in record 1502 of the viewer database 1500, the viewer having a viewer identifier 1520 of “B-23-45” provides a financial account identifier 1522 associated with a financial account from which the viewing fees are deducted. The viewer identifier is typically assigned and the credit in the financial account may be verified. At step S19-8, the viewer information is then stored in the viewer database 1500. The processor 1222 in step S19-9 transmits the additional picture selected by the viewer to the corresponding viewer device 1004 for viewing. In step S19-10, the amount of the picture viewing fee 1426 stored in the picture database 1400 is charged to the viewer's financial account identifier 1522.

In step S19-11, the total viewing fees owed 1524 in the viewer database 1500 is increased by the amount of the picture viewing fee 1426. In addition, the number of times viewed 1428 associated with the requested picture in the picture database 1400 is incremented by one. The processor 1222 further updates or increments the amount in the total collected fees 1328 in the home database 1300 (although this may not be performed until the central authority actually receives payment from the viewer). The processor 1222 in step S19-12 then stores an indication of the viewer's interest in the collected demand database 1600 in association with the home identifier 1320 of the home whose pictures are being viewed.

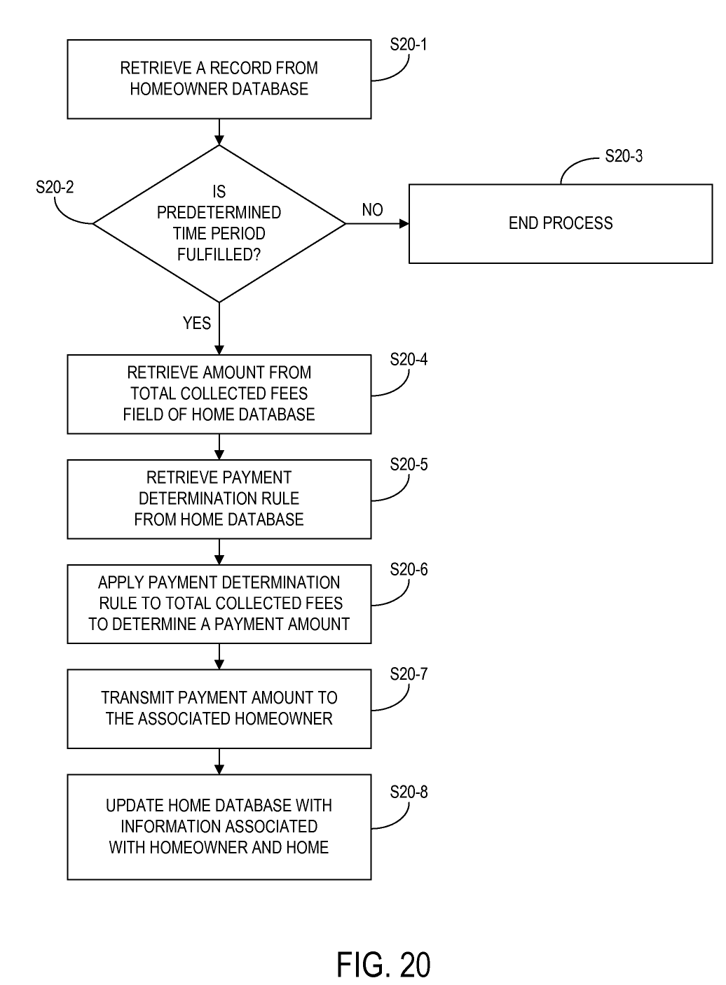

FIG. 20 is a flowchart that illustrates the steps of an embodiment of the process performed by a data processing system, such as remote home viewing system 1000, for providing a payment to a homeowner according to an embodiment of the present invention.

Processing starts at step S20-1 where the processor 1222 retrieves a record from the home database 1300. At step S20-2, the processor 1222 checks the payment date 1330 field of the home database 1300 to determine whether the time period/due date has been fulfilled. If not, the process ends at step S20-3. If the time period has been fulfilled (e.g., it is the date on which the central authority has agreed to provide a payment to the homeowner), the processor 1222 at step S20-4 retrieves the total collected fees 1328.

At steps S20-5 and S20-6, the processor 1222 retrieves the payment determination rule 1326. The payment determination rule 1326 is then applied to the total collected fees 1328 to determine the payment amount to the homeowner. Specifically, these steps are performed when the payment determination rule 1326 defines payment as, for example, a percent of the total collected fees 1328. Note, however, that the compensation provided to the homeowner may be based on any type of compensation information.

For example, the compensation may be based on the number of times a picture of a home is viewed by viewers. Alternatively, the payment amount may be based on the popularity of the geographic area of the home. Homeowners may receive a payment that is, for example: (i) a percentage of the total amount received from viewers in a defined amount of time; (ii) a flat rate for each time a picture is viewed; (iii) a minimum amount; (iv) a fixed amount; or (v) a combination of any of these. For example, a viewer may receive 50% of the money collected by the central authority for displaying pictures of the homeowner's home. The payment provided to the homeowner may be based on (i.e., based at least partly on) information associated with the home, including, for example: (i) information associated with the value of the home; (ii) information associated with the popularity of the home; (iii) information associated with the amount (or type) of information provided by the homeowner to the remote viewing system and/or to viewers; (iv) the homeowner's willingness to sell the home; and/or (v) any other information related to the home, the location of the home, the homeowner, etc. The payment is not necessarily related to the collected viewing fees.

In one embodiment, the payment is distributed to the homeowner monthly, in the form of a discount off of a mortgage, but a homeowner may also be paid non-periodically (e.g., once, when the homeowner first agrees to participate in the remote home viewing system 1000) in place of, or in addition to, periodic payments.

For example in record 1304, “Doris Jones” will receive $2.52 (i.e., 1% of $252.20) on Jun. 17, 1999. Note that such payments may be rounded up (or down) or may be accumulated until a predetermined amount of payment is owed to the homeowner (e.g., the central authority may wait until the a payment of $5.00 is owed to the homeowner). Alternatively, the payment determination rule may be applied to the number of times viewed 1428 field of the picture database 1400. For example, in record 1302 “Doris Jones” will receive $1.25 (i.e., $0.05 for each of the 25 number of times viewed 1428 stored in the picture database 1400). After the payment amount is determined, at step S20-7 the processor 1222 transmits the determined payment amount to the financial account of the homeowner identified in the financial account identifier 1324 field of the home database 1300.

Finally, at step S20-8 the processor 1222 updates information associated with the home database 1300 and picture database 1400. For example, the payment date 1330 is updated to the next scheduled payment due date.

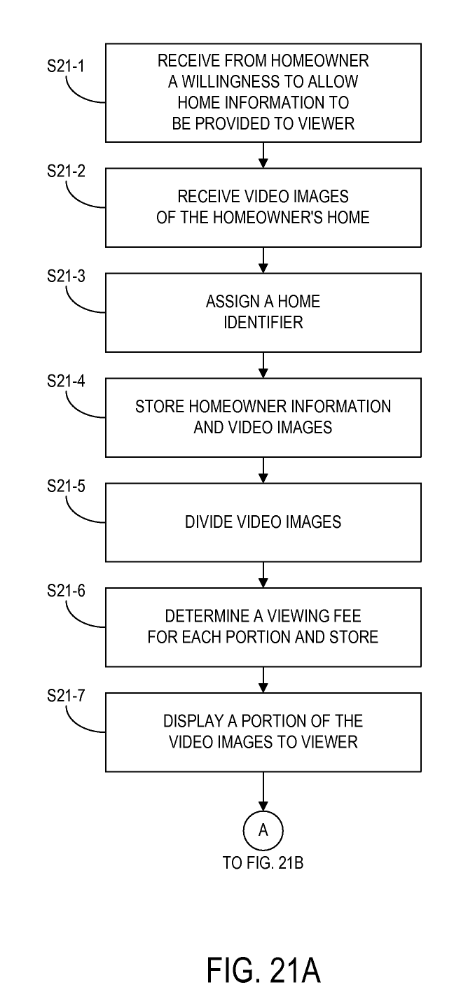

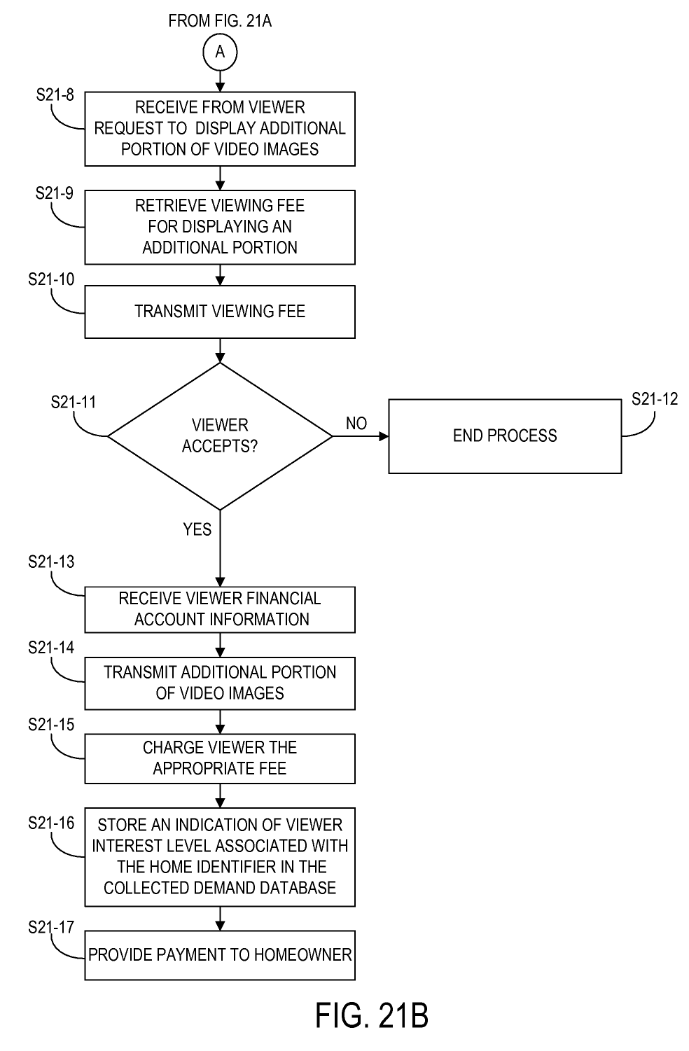

FIGS. 21A-21B are a flowchart that illustrates the steps of an embodiment of the process performed by a data processing system, such as remote home viewing system 1000, for storing and displaying video images of a homeowner's home.

Processing starts at step S21-1, where the processor 1222 receives from a homeowner an indication of a willingness to allow home information to be provided to a viewer. At step S21-2 and step S21-3, the processor 1222 receives video images of the homeowner's home associated with an assigned homer identifier 1320. The homeowner information as described herein and the video images are stored, at step S21-4, in the home database 1300 and picture database 1400, respectively.

At step S21-5, the video images are divided into predetermined periods of time. This may be done, for example, by simply dividing the video images into thirty second portions. More advanced divisions, such as divisions based on changes in scene, may be performed, such as with the use of VIDEOLOGGER® 3.0 software available from Virage Inc. of San Mateo, Calif. The processor 1222 at step S21-6 determines a picture viewing fee 1426 for each of the divisions of the video images and stores the fee in the picture database 1400. For example in record 1408, a viewer may view the video images for “$0.25” for each “30-second” length of the video images after the initial thirty seconds (which are free).

At step S21-7, the processor 1222 displays a portion of the video images in response to a request by a viewer free of charge. In response to receiving an indication by a viewer to display additional portions of the video images at step S21-8, the processor 1222 in steps S21-9 and S21-10 retrieves the picture viewing fee 1426 and informs the viewer about the fee (e.g., by transmitting the picture viewing fee 1426 value to the viewer).

If the viewer does not accept the picture viewing fee at step S21-11, the process ends at step S21-12. If the viewer does accept the picture viewing fee, at step S21-13 and S21-14 the processor 1222 retrieves the viewer financial account identifier 1522 from the viewer database 1500 and transmits an additional portion of the video images to the viewer. If the viewer is a new viewer, the system assigns him an identifier and receives his financial account information. If the viewer has used the system 1000 before, the system 1000 may recognize him by, for example, his password or a “cookie”. In the alternative, a timer can begin running when a viewer accesses the video images, and when the timer reaches a predetermined time period (e.g., thirty seconds), the viewer is prompted to pay a viewing fee.

At step S21-15, the processor 1222 charges the viewer's financial account the appropriate fee for viewing the video images. Information, such as an indicated level of interest and an offer price, is stored as an indication of the viewer demand in association with the home identifier 1620 in the collected demand database 1600 at step S21-16 and the appropriate payment is provided to the homeowner at step S21-17.

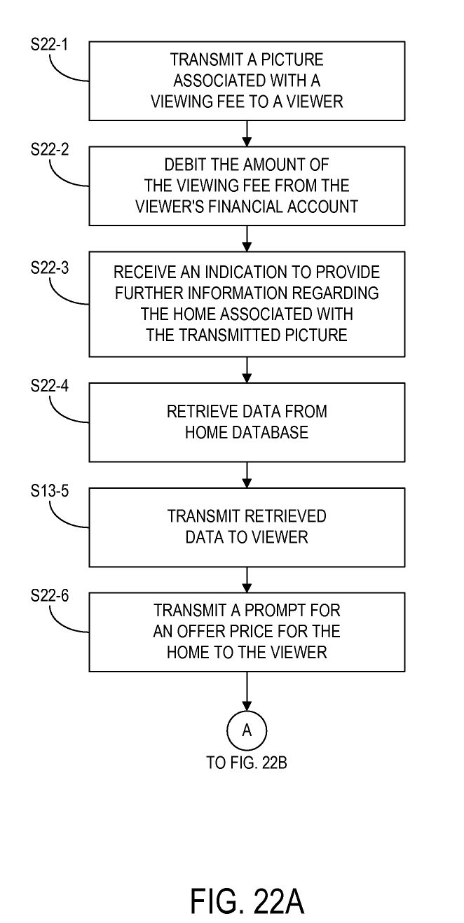

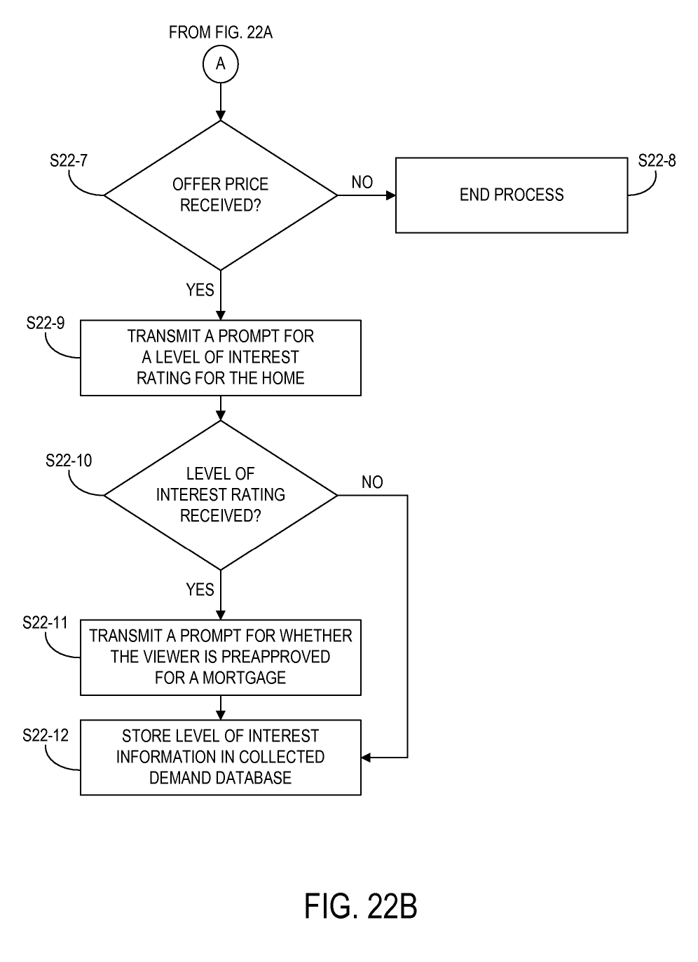

FIGS. 22A-22B are a flowchart that illustrates the steps of a process performed by a data processing system, such as remote home viewing system 1000, for collecting demand according to an embodiment of the present invention.

Processing starts at step S22-1, where the processor 1222 transmits a picture, associated with a picture viewing fee 1426, to the viewer. The processor 1222 at step S22-2 debits the amount of the picture viewing fee 1426 using the financial account identifier 1522 from the viewer database 1500.

At step S22-3 the processor 1222 receives an indication to provide further information regarding the home associated with the transmitted picture. Data from the home database 1300 is then retrieved and transmitted to the viewer at steps S22-4 and S22-5. The processor 1222 then transmits a prompt to the viewer at step S22-6 requesting the viewer provide an offer price for the associated home. According to an embodiment of the present invention, the viewer is not bound to buy the homeowner's home if the homeowner accepts the offer price. The offer price may be used, for example, to collect information associated with the demand of the home (e.g., the offer price may be hypothetical). The viewer may, however, be obligated to go see the home and/or enter into negotiations with the homeowner to buy the home if the homeowner finds the offer price acceptable.

If an offer price is not received in step S22-7, the process ends at step S22-8. If an offer is received, the processor 1222 transmits at step S22-9 a prompt requesting a level of interest rating for the home from the viewer. According to an embodiment of the present invention, the level of interest may be determined by the system and not by the viewer.

If the level of interest rating is not received at step S22-10, then the processor 1222 receives and stores collected demand information in the collected demand database 1600 at step S22-12. If the level of interest is received, then a prompt is transmitted to the viewer asking the viewer if the viewer is pre-approved for a mortgage at step S22-11. According to an embodiment of the present invention, the viewer may be prompted for information that allows the system to pre-approve the viewer for a mortgage, or it may be determined based on the identity of the viewer whether the viewer is pre-approved (e.g., by accessing a database using the viewer's Social Security number).

At step S22-12, the processor 1222 receives and stores collected demand information in the collected demand database 1600.

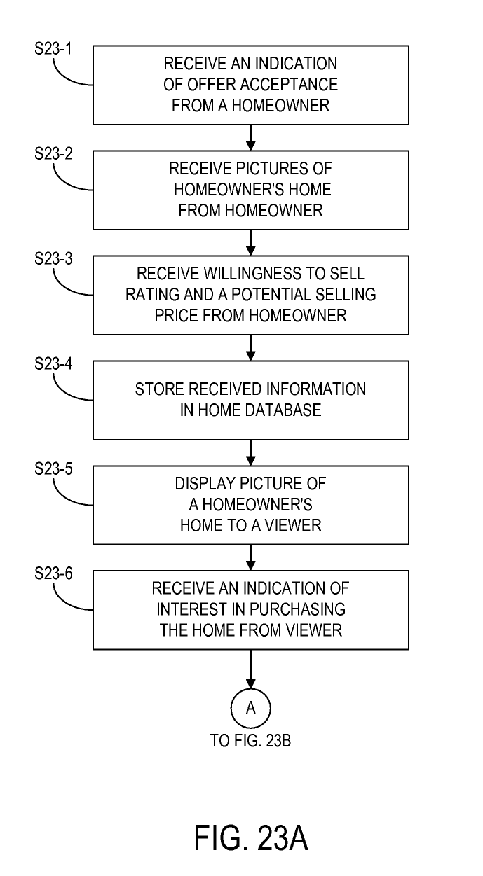

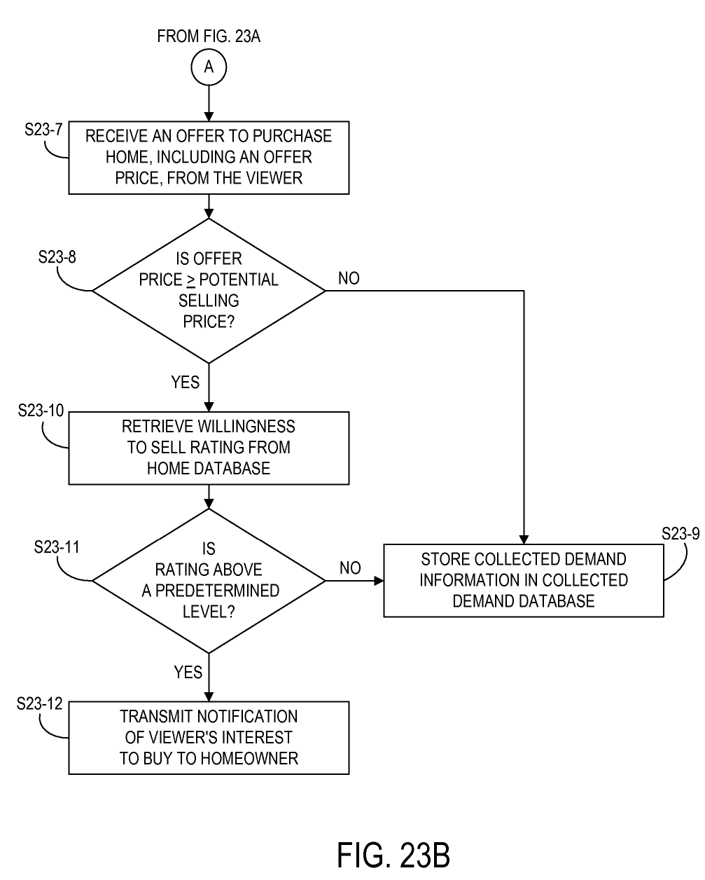

FIGS. 23A-23B illustrate the steps of a process performed by a data processing system, such as remote home viewing system 1000, for receiving an offer price from a viewer and notifying the homeowner of the viewer's interest in purchasing the homeowner's home.

In one embodiment, the homeowner can set a minimum price at which he may sell his home if somebody offers that price. This price could be well above market value if the homeowner is not currently interested in selling his home. If a viewer pays to see the pictures of the home and offers a price that matches or tops the homeowner's minimum price, then the central server 1006 notifies the homeowner and the homeowner decides whether to sell his home. The viewer may be informed of the homeowner's minimum price when submitting an offer price.

In another embodiment, a homeowner names a price at which he would sell his or her home (and this price may be hidden from viewers). If a viewer offers at least as much as the homeowner's named price, the homeowner may be bound to sell his home. Alternately, a penalty is imposed on the homeowner if he refuses to sell his home (e.g., a percentage increase in the homeowner's mortgage is imposed). According to another embodiment of the present invention, a viewer may also be bound when an offer is accepted by a homeowner. This may, of course, be contingent on the actual condition of the home as compared to the information about the home provided by the homeowner.

In another embodiment, a homeowner indicates how willing he would be to sell his home if a viewer is interested. The homeowner's willingness is given a rating that is stored in the home database 1300. For example, the rating is “A” for willing, “B” for reluctant and “C” for not willing at all. The homeowner also gives a minimum price at which he would be willing to sell his home. This information can be used in descriptions of the homes or it can be used as a guideline for the central authority to determine when to inform the homeowner of a viewer's interest. For example, if a homeowner has rating “A” and a viewer offers to pay a price equal to or above the set minimum price, the central authority informs the homeowner of the offer by means of an indication on the real estate site, a telephone call, or an indication on the monthly payment. If the homeowner has a rating “C” and a viewer offers to buy the home for a price equal to or above the set minimum price, the system can determine whether to send the offer information to the viewer based on other factors such as how much the offered price is above the minimum price. A homeowner can receive a greater amount of payment for including information about his willingness to sell. For example, the central authority prompts the homeowner for a rating of willingness, and if the homeowner agrees, he can be given a greater percentage of the collected fees. Alternately, the homeowner can be given a higher periodic payment based on the rating of willingness he gives himself, e.g., more payment for an “A” rating than a “B” rating. If the homeowner decides to accept an offer from a viewer, the transaction is completed in a conventional fashion.

Processing starts at step S23-1, where the processor 1222 receives an indication of an offer acceptance from a homeowner to display pictures of the homeowner's home. At steps S23-2 and S23-3, the processor 1222 receives pictures of the homeowner's home from the homeowner and a rating of a willingness to sell 1346 and a potential selling price 1348 from the homeowner. The received information is then stored in the home database 1300.

At step S23-5, the processor 1222 displays pictures of a homeowner's home to a viewer. The processor 1222 then receives from the viewer an indication of interest in purchasing the home, and an offer price from the viewer at steps S23-6 and S23-7. If the viewer's offer price is less than the homeowner's potential selling price 1348 at step S23-8, then the collected demand information is stored in the collected demand database 1600 at step S23-9. If the viewer's offer price is greater than or equal to the homeowner's selling price, the processor 1222 retrieves the rating of willingness to sell 1346 the home from the home database 1300 at step S23-10.

If the rating is above a predetermined level at step S23-11, the processor 1222 transmits to the homeowner a notification of viewer's interest to buy the home at step S23-12. If not, then the collected demand information is stored in the collected demand database 1600 at step S23-9.

Thus, embodiments of the present invention let a homeowner receive payment(s) for agreeing to anonymously let information (e.g., a photograph and/or video images of the features of a home) about his home be provided to a viewer who may, in some cases, pay to receive information about not-for-sale homes that meet certain viewer-set criteria. The present invention may also help anticipate future homes that will be placed on the market. For example, if a homeowner is considering a job transfer that requires relocation, he or she may have an additional incentive to sell a home if the demand level for his home is already known. Thus, this invention may create a market for homes that are otherwise not for sale. Furthermore, viewers may use the system to formulate ideas and preferences for features of homes, and real estate brokers may better anticipate what potential buyers prefer in a home.

To further the anonymity of a homeowner, identifying information about a home may be deleted from the displayed picture of the home. For example, the license plate on a car, a mailbox number, a family picture, a local landmark, etc. may be removed from the picture. When pictures are received by the central authority, the central authority can remove identifying information before the picture is displayed to a viewer. For example, the central authority can manually review pictures and remove identifying information.

In addition, homeowners can indicate how much information they are willing to give out regarding the location of their home (e.g., they can select the level at which their anonymity will be maintained). For example, four levels of anonymity may be offered to homeowners: region, state, county, and town. The payment given to a homeowner could be partially based on which of the four levels is chosen.

In one embodiment, viewers may send anonymous e-mails, via the central server, to the homeowners. These e-mails serve to convey general demand and can even be a request to see the homeowner's home. The homeowner can choose to respond to e-mails from viewers. The homeowner can also submit rules to the central server about criteria that viewers must fulfill before sending e-mail to the homeowner. For example, viewers who have been pre-approved for a mortgage amount that is above a predetermined amount (e.g., enough to purchase certain homes), would be able to inform a homeowner via e-mail of his interest in the homeowner's home. The central server could also store and collect demand for each home, and homeowners can access the collected demand when ready to sell. The central authority contacts viewers stored in association with the pre-approved mortgage and who have expressed interest in the newly available home.

### CONCLUSION

It will be apparent to those skilled in the art that various modifications and variations can be made in the system and method of the present invention without departing from the spirit or scope of the invention. The present invention covers the modifications and variations of this invention provided they come within the scope of the appended claims and their equivalents.

What is claimed is:

1. A method, comprising:
determining a real estate query submitted by a potential real estate buyer;
determining that information associated with a parcel of real estate that is not currently listed as being for sale at least partially satisfies the real estate query;
determining that an interest level of the potential real estate buyer in the unlisted parcel of real estate is greater than or equal to a pre-determined interest level threshold; and
notifying, based on the determining that the interest level of the potential real estate buyer in the unlisted parcel of real estate is greater than or equal to the pre-determined interest level threshold, an owner of the unlisted parcel of real estate that the potential real estate buyer is interested in the unlisted parcel of real estate.

2. The method of claim 1, further comprising:
determining the interest level of the potential real estate buyer in the unlisted parcel of real estate.

3. The method of claim 2, wherein the determining of the interest level of the potential real estate buyer in the unlisted parcel of real estate comprises:
determining that the potential real estate buyer is pre-approved for a mortgage.

4. The method of claim 3, further comprising:
pre-approving the potential real estate buyer for the mortgage.

5. The method of claim 3, further comprising:
verifying, via a third-party mortgage entity, that the potential real estate buyer is pre-approved for the mortgage.

6. The method of claim 3, wherein the determining of the interest level of the potential real estate buyer in the unlisted parcel of real estate further comprises:
determining that an amount of the pre-approved mortgage is greater than or equal to a stated value of the unlisted parcel of real estate.

7. The method of claim 6, further comprising:
arranging for an appraisal of the unlisted parcel of real estate to define the stated value as an appraised value of the unlisted parcel of real estate.

8. The method of claim 6, wherein the stated value comprises an appraised value, further comprising:
verifying, via a third-party appraisal entity, the appraised value of the unlisted parcel of real estate.

9. The method of claim 2, wherein the determining of the interest level of the potential real estate buyer in the unlisted parcel of real estate comprises:
comparing an amount that the potential home buyer may be willing to pay for the unlisted parcel of real estate to an appraised value of the unlisted parcel of real estate.

10. The method of claim 2, wherein the determining of the interest level of the potential real estate buyer in the unlisted parcel of real estate comprises:
comparing an amount that the potential home buyer may be willing to pay for the unlisted parcel of real estate to an owner-defined potential selling price for the unlisted parcel of real estate.

11. The method of claim 2, wherein the determining of the interest level of the potential real estate buyer in the unlisted parcel of real estate comprises:
determining a number of pictures of the unlisted parcel of real estate that are viewed by the potential real estate buyer.

12. The method of claim 2, wherein the determining of the interest level of the potential real estate buyer in the unlisted parcel of real estate comprises:
determining an amount of time spent by the potential real estate buyer in viewing one or more pictures of the unlisted parcel of real estate.

13. The method of claim 1, wherein the pre-determined interest level threshold is defined by the owner of the unlisted parcel of real estate.

14. The method of claim 1, wherein the notifying comprises arranging for an anonymous communications session between the owner of the unlisted parcel of real estate and the potential real estate buyer.

15. An apparatus, comprising:
a processor; and
a storage device in communication with said processor and storing instructions adapted to be executed by said processor to:
perform the method of claim 1.

16. A medium storing instructions adapted to be executed by a processor to:
perform the method of claim 1.

17. A method, comprising:
determining a real estate query submitted by a potential home buyer;
determining that information associated with a home that is not currently listed as being for sale at least partially satisfies the real estate query;
determining a viewing fee associated with a picture of the unlisted home; and
charging, in the case that an interest level of the potential home buyer is greater than or equal to a pre-determined threshold, the fee to the potential home buyer in exchange for permitting the potential home buyer to view the picture of the unlisted home.

18. The method of claim 17, further comprising:
receiving, from an owner of the unlisted home, one or more of: (i) the information associated with the unlisted home; and (ii) the picture of the unlisted home.

19. The method of claim 17, wherein the viewing fee is based on one or more of: (i) a number of pictures of the unlisted home that have already been viewed by the potential home buyer; (ii) a number of other potential home buyers that have previously viewed the picture of the unlisted home; (iii) a fee level associated with the picture of the unlisted home, wherein the fee level comprises one of a plurality of possible fee levels; and (iv) a picture size associated with the picture of the unlisted home.

20. The method of claim 17, wherein the viewing fee comprises an agreement by the potential home buyer to provide one or more pictures of a home owned by the potential home buyer.

21. The method of claim 20, wherein the home owned by the potential home buyer is not currently listed as being for sale.

22. The method of claim 17, further comprising:
providing payment to an owner of the unlisted home in exchange for an agreement by the owner to allow the picture of the unlisted home to be provided to the potential home buyer.

23. The method of claim 22, further comprising:
determining the payment.

24. The method of claim 22, wherein the payment is based at least in part on a number of times that the picture of the unlisted home is viewed by a plurality of potential home buyers.

25. The method of claim 22, wherein the payment is based on an amount of fees collected in association with the viewing of the picture of the unlisted home by the plurality of potential home buyers.

26. The method of claim 22, wherein the payment is based at least in part on a level of willingness of the owner to sell the unlisted property.

27. The method of claim 26, wherein the level of willingness of the owner to sell the unlisted property is determined automatically based on information associated with the owner.

28. The method of claim 27, wherein the information associated with the owner comprises one or more of: (i) a level of anonymity selected by the owner; (ii) an owner-defined potential selling price of the unlisted home; and (iii) a comparison of the owner-defined potential selling price of the unlisted home to an appraised value of the unlisted home.

29. The method of claim 26, wherein the level of willingness of the owner to sell the unlisted property is determined based on a selection by the owner.

30. The method of claim 17, further comprising:
determining the interest level of the potential home buyer.

31. The method of claim 17, further comprising:
notifying an owner of the unlisted home of the interest level of the potential home buyer.

32. The method of claim 17, wherein the pre-determined threshold is defined by an owner of the unlisted property.

33. An apparatus, comprising:
a processor; and
a storage device in communication with said processor and storing instructions adapted to be executed by said processor to:
perform the method of claim 17.

34. A medium storing instructions adapted to be executed by a processor to:
perform the method of claim 17.

35. A method, comprising:
providing information associated with a property that is not currently listed as being for sale to a plurality of potential property buyers;
determining, based on information associated with each potential property buyer of the plurality of property buyers, a level of interest of each potential property buyer with respect to the unlisted property;
calculating, based at least in part on the levels of interest of the plurality of potential property buyers, a demand for the unlisted property;
receiving, from an owner of the unlisted property, request for the calculated demand; and
providing, in response to the inquiry, the calculated demand to the owner.

36. The method of claim 35, wherein the level of interest of each potential property buyer of the plurality of potential property buyers is based on one or more of: (i) a number of pictures of the unlisted property viewed by the potential property buyer; (ii) an amount of time spent by the potential property buyer in viewing one or more pictures of the unlisted property; (iii) an amount that the potential property buyer may be willing to spend to purchase the unlisted property; (iv) a difference between the amount that the potential property buyer may be willing to spend to purchase the unlisted property and an appraised value of the unlisted property; (v) a difference between the amount that the potential property buyer may be willing to spend to purchase the unlisted property and a potential selling price of the unlisted property that is defined by the owner; and (vi) an amount of pre-approved financing procured by the potential property buyer.

37. The method of claim 35, wherein the providing of the information associated with the unlisted property to the plurality of potential property buyers comprises:
facilitating a transmitting of an indication of the information associated with the unlisted property to a set top box associated with each of the potential property buyers of the plurality of potential property buyers.

38. An apparatus, comprising:
a processor; and
a storage device in communication with said processor and storing instructions adapted to be executed by said processor to:
perform the method of claim 35.

39. A medium storing instructions adapted to be executed by a processor to:
perform the method of claim 35.
